(19) United States
(12) Patent Application Publication
(10) Pub. No.: US 2026/0214119 A1
(43) Pub. Date: Jul. 23, 2026

(54) FRAUD DETECTION APPARATUS, FRAUD DETECTION METHOD, AND RECORDING MEDIUM

(71) Applicant: Spider Labs, Inc., Tokyo (JP)

(72) Inventors: Eurico DOIRADO, Tokyo (JP); Akira AKAISHI, Tokyo (JP)

(21) Appl. No.: 19/140,256

(22) PCT Filed: Nov. 29, 2023
(86) PCT No.: PCT/JP2023/042794

§ 371 Date: Jun. 17, 2025

(30) Foreign Application Priority Data
Dec. 23, 2022 (JP) 2022-206164

(51) Int. Cl. H04L 9/40

(52) U.S. Cl. CPC H04L 63/1483; H04L 63/0861

(57) ABSTRACT

A fraud detection apparatus includes: a network information acquisition unit that acquires network information; a network fraud detection unit that performs fraud detection targeting the network, using the network information acquired by the network information acquisition unit, to acquire a network detection result; a site information acquisition unit that acquires site information; a site fraud detection unit that performs fraud detection targeting a site, using the site information, to acquire a site detection result; an IP address information acquisition unit that acquires IP address information; an IP address fraud detection unit that performs fraud detection targeting an IP address, using the IP address information, to acquire an IP address detection result; and an output unit that outputs the network detection result, the site detection result, and the IP address detection result.

### TECHNICAL FIELD

The present invention relates to a fraud detection apparatus and the like that performs fraud detection targeting networks, sites, and IP addresses.

### BACKGROUND ART

Conventionally, there has been a system that detects user fraud through machine learning using feature values according to the user's service usage status (see Patent Document 1).

### CITATION LIST

### Patent Document

Patent Document 1: JP 7133107B

### SUMMARY OF INVENTION

### Technical Problem

However, the conventional technique is not capable of comprehensively detecting fraud across all layers of a three-layer structure, namely a network, site, and IP address layer.

### Solution to Problem

A fraud detection apparatus according to one aspect of the present invention is a fraud detection apparatus including: a network information acquisition unit that acquires network information regarding a network including one or more sites; a network fraud detection unit that performs fraud detection targeting the network, using the network information acquired by the network information acquisition unit, to acquire a network detection result; a site information acquisition unit that acquires site information regarding a site; a site fraud detection unit that performs fraud detection targeting the site, using the site information acquired by the site information acquisition unit, to acquire a site detection result; an IP address information acquisition unit that acquires IP address information regarding an IP address; an IP address fraud detection unit that performs fraud detection targeting the IP address, using the IP address information acquired by the IP address information acquisition unit, to acquire an IP address detection result; and an output unit that outputs the network detection result, the site detection result, and the IP address detection result.

With such a configuration, it is possible to perform comprehensive fraud detection across all layers of a three-layer structure, namely a network, site, and IP address layer.

A fraud detection apparatus according to a second aspect of the present invention is the fraud detection apparatus according to the first aspect of the invention, further including: a user operation information acquisition unit that acquires user operation information regarding an operation performed by a user; and a user fraud detection unit that performs fraud detection targeting the user, using the user operation information acquired by the user operation acquisition unit, to acquire a user detection result, wherein the output unit further outputs the user detection result.

With such a configuration, it is possible to perform more comprehensive fraud detection, including fraud detection targeting users.

A fraud detection apparatus according to a third aspect of the present invention is the fraud detection apparatus according to the first or second aspect of the invention, wherein the network information acquisition unit acquires two or more network attribute values including one or more network attribute values out of: the number of application downloads in the network, the number of sites belonging to the network, the number of accesses from user terminals with a non-Japanese language setting, the number of application installations from user terminals with a non-Japanese language setting, the number of accesses from user terminals with non-Japan access origins, the number of application installations from user terminals with non-Japan access origins, the number of operation identifiers corresponding to CV operations, the number of accesses from user terminals of types identified by terminal type identifiers of terminals that satisfy a predetermined condition, and the number of accesses from user terminals equipped with OSs identified by OS type identifiers of OSs that satisfy a predetermined condition, and the network fraud detection unit uses the two or more network attribute values to perform the fraud detection targeting the network, thereby acquiring the network detection result.

With such a configuration, it is possible to perform appropriate fraud detection targeting networks.

A fraud detection apparatus according to a fourth aspect of the present invention is the fraud detection apparatus according to the first or second aspect of the invention, wherein the network information acquisition unit acquires a network attribute value that is network distribution information regarding the distribution of feature values of the network, and the network fraud detection unit uses the network attribute value to perform the fraud detection targeting the network, thereby acquiring the network detection result.

With such a configuration, it is possible to perform more appropriate fraud detection targeting networks.

A fraud detection apparatus according to a fifth aspect of the present invention is the fraud detection apparatus according to the fourth aspect of the invention, further including: a legitimate information storage unit in which network legitimate distribution information specifying legitimate information regarding the network distribution information is stored, wherein the network fraud detection unit acquires network distribution difference information regarding a difference between the network distribution information acquired by the network information acquisition unit and the network legitimate distribution information, and uses the network distribution difference information to acquire the network detection result, and the fraud detection apparatus further includes a legitimate information update unit that updates the network legitimate distribution information when a predetermined update condition is satisfied.

With such a configuration, it is possible to perform more appropriate fraud detection targeting networks.

A fraud detection apparatus according to a sixth aspect of the present invention is the fraud detection apparatus according to the first or second aspect of the invention, wherein the site information acquisition unit acquires site distribution information regarding the distribution of feature values of the site, and the site fraud detection unit uses the site distribution information to perform the fraud detection targeting the site, thereby acquiring the site detection result.

With such a configuration, it is possible to perform appropriate fraud detection targeting sites.

A fraud detection apparatus according to a seventh aspect of the present invention is the fraud detection apparatus according to the sixth aspect of the invention, wherein the site distribution information includes any one of: information regarding the distribution of CTITs; information regarding the distribution of OS version shares, which are the shares of OS versions of user terminals from which the site is accessed; information regarding the distribution of user terminal shares, which are the shares of types of user terminals from which the site is accessed; information regarding the distribution of provider shares, which are the shares of types of providers from which the site is accessed; and information regarding the distribution of regional shares, which are shares of region types from which the site is accessed.

With such a configuration, it is possible to perform more appropriate fraud detection targeting sites.

A fraud detection apparatus according to an eighth aspect of the present invention is the fraud detection apparatus according to the sixth or seventh aspect of the invention, further including: a legitimate information storage unit in which site legitimate distribution information specifying legitimate information for the site distribution information is stored, wherein the site fraud detection unit acquires site distribution difference information regarding a difference between the site distribution information acquired by the site information acquisition unit and the site legitimate distribution information, and uses the site distribution difference information to acquire the site detection result, and the fraud detection apparatus further comprises a legitimate information update unit that updates the site legitimate distribution information when a predetermined update condition is satisfied.

With such a configuration, it is possible to perform more appropriate fraud detection targeting sites.

A fraud detection apparatus according to a ninth aspect of the present invention is the fraud detection apparatus according to the first aspect of the invention, wherein the site information acquisition unit acquires two or more tag counts, which are the numbers of specific tags of two or more types used to describe the site, and the site fraud detection unit uses the two or more tag counts to perform the fraud detection targeting the site, thereby acquiring the site detection result.

With such a configuration, it is possible to perform more appropriate fraud detection targeting sites.

A fraud detection apparatus according to a tenth aspect of the present invention is the fraud detection apparatus according to the ninth aspect of the invention, wherein the site fraud detection unit clusters two or more sites using two or more tag counts of each of the two or more sites, and judges a site to be fraudulent and acquires the site detection result if the site belongs to the same cluster as a site judged to be fraudulent by an inspection performed using the two or more tag counts, even if the site has not been judged to be fraudulent by the inspection performed using the two or more tag counts.

With such a configuration, it is possible to perform more appropriate fraud detection targeting sites.

A fraud detection apparatus according to an eleventh aspect of the present invention is the fraud detection apparatus according to the first or second aspect of the invention, wherein the site information acquisition unit acquires site information regarding two or more sites, and the site fraud detection unit performs a preliminary inspection, using the site information, to judge whether or not each of two or more sites is a candidate for being a fraudulent site, and performs a detailed inspection, using the site information of one or more sites judged to be fraudulent in the preliminary inspection, to judge whether or not each of the one or more sites is a fraudulent site, thereby acquiring the site detection result.

With such a configuration, it is possible to perform more appropriate fraud detection targeting sites.

A fraud detection apparatus according to a twelfth aspect of the present invention is the fraud detection apparatus according to the first aspect of the invention, wherein the IP address information acquisition unit acquires one or more IP address attribute values including type-specific access counts, which are the respective numbers of user terminals accessing the IP address for one or more user terminal types, and the IP address fraud detection unit uses the one or more IP address attribute values to perform the fraud detection targeting the IP address, thereby acquiring the IP address detection result.

With such a configuration, it is possible to perform appropriate fraud detection targeting IP addresses.

A fraud detection apparatus according to a thirteenth aspect of the present invention is the fraud detection apparatus according to the twelfth aspect of the invention, wherein the IP address information acquisition unit acquires, for an IP address, two or more IP address attribute values including a type identifier that specifies a type of a user terminal and size information that specifies a screen size of the user terminal, and the IP address fraud detection unit acquires an IP address detection result indicating that an IP address is fraudulent when the number of two or more IP address attribute values for which a screen size corresponding to the type identifier included in the two or more IP address attribute values does not match the screen size indicated by the size information is sufficiently large to satisfy a fraud condition.

With such a configuration, it is possible to perform more appropriate fraud detection targeting IP addresses.

A fraud detection apparatus according to a fourteenth aspect of the present invention is the fraud detection apparatus according to the second aspect of the invention, wherein the user operation acquisition unit acquires two or more pieces of user operation information paired with a piece of finger print information, and the user fraud detection unit acquires a user detection result indicating that a user is fraudulent when the two or more pieces of user operation information include a large number of pieces of operation information indicating a specific operation, the large number being sufficiently large to satisfy a frequency condition.

With such a configuration, it is possible to perform appropriate fraud detection targeting users.

A fraud detection apparatus according to a fifteenth aspect of the present invention is the fraud detection apparatus according to the fourteenth aspect of the invention, further including: a legitimate information storage unit in which frequency legitimate information indicating a legitimate frequency of the pieces of operation information indicating the specific operation, wherein the user fraud detection unit acquires a user detection result indicating that a user is fraudulent when the two or more pieces of user operation information include a large number of pieces of frequency information of operation information indicating the specific operation, the large number being sufficiently large to satisfy a frequency condition relative to the frequency legitimate information.

With such a configuration, it is possible to perform more appropriate fraud detection targeting users.

### Advantageous Effects of Invention

A fraud detection apparatus according to the present invention is capable of comprehensively detecting fraud across all layers of a three-layer structure, namely a network, site, and IP address layer.

### BRIEF DESCRIPTION OF DRAWINGS

FIG. 1 is a conceptual diagram of a fraud detection system A according to a first embodiment.

FIG. 2 is a block diagram of the fraud detection system A according to the same.

FIG. 3 is a block diagram of a fraud detection apparatus 1 according to the same.

FIG. 4 is a flowchart illustrating an example of operation of the fraud detection apparatus 1 according to the same. FIG. 5 is a flowchart illustrating an example of network fraud processing according to the same.

FIG. 6 is a flowchart illustrating an example of site fraud processing according to the same.

FIG. 7 is a flowchart illustrating an example of IP address fraud processing according to the same.

FIG. 8 is a flowchart illustrating an example of user fraud processing according to the same.

FIG. 9 is a flowchart illustrating an example of legitimate information update processing according to the same. FIG. 10 is a flowchart illustrating an example of operation of a server 2 according to the same.

FIG. 11 is a flowchart illustrating an example of operation of a user terminal 3 according to the same.

FIG. 12 is a diagram showing a fraud condition management table according to the same.

FIG. 13 is a diagram showing the fraud condition management table according to the same.

FIG. 14 is a diagram showing the fraud condition management table according to the same.

FIG. 15 is a diagram showing an example of output according to the same.

FIG. 16 is a diagram showing an example of output according to the same.

FIG. 17 is a diagram showing an example of output according to the same.

FIG. 18 is a diagram showing an example of output according to the same.

FIG. 19 is an overview diagram of a computer system according to the same.

FIG. 20 is a block diagram of the computer system according to the same.

### DESCRIPTION OF EMBODIMENTS

Hereinafter, embodiments of the fraud detection apparatus and the like will be described with reference to the drawings. Note that in the embodiments, constituent elements with the same reference signs perform similar operations, and therefore, repeated descriptions thereof may be omitted.

### First Embodiment

In the present embodiment, a fraud detection system including a fraud detection apparatus that performs fraud detection targeting networks, fraud detection targeting sites, and fraud detection targeting IP addresses and outputs the detection results for each will be described. Note that a network includes one or more sites.

In addition, in the present embodiment, a fraud detection system including a fraud detection apparatus that also performs fraud detection targeting users and outputs the detection results will be described.

For fraud detection targeting a network, for example, information regarding the relationship between the number of application downloads and the number of sites belonging to the network, and the distribution of legitimate feature values regarding the network are used. The distribution of legitimate feature values is, for example, updated periodically.

For fraud detection targeting a site, for example, the number of two or more tags in the HTML of a fraudulent site is used. Also, for fraud detection targeting sites, for example, a method is used where candidate fraudulent sites are detected through a preliminary inspection, and fraudulent sites are detected from the candidates through a detailed inspection.

For fraud detection targeting IP addresses, for example, the access count for each type of user terminal is used.

Furthermore, for fraud detection targeting a user, for example, information regarding specific operations included in information regarding operations performed by the user is used.

In the present embodiment, the fact that information X is associated with information Y means that the information Y can be obtained from the information X, or the information X can be obtained from the information Y, and the method of association is not limited. The information X and the information Y may be linked to each other or present in the same buffer. The information X may be contained in the information Y, or the information Y may be contained in the information X, for example.

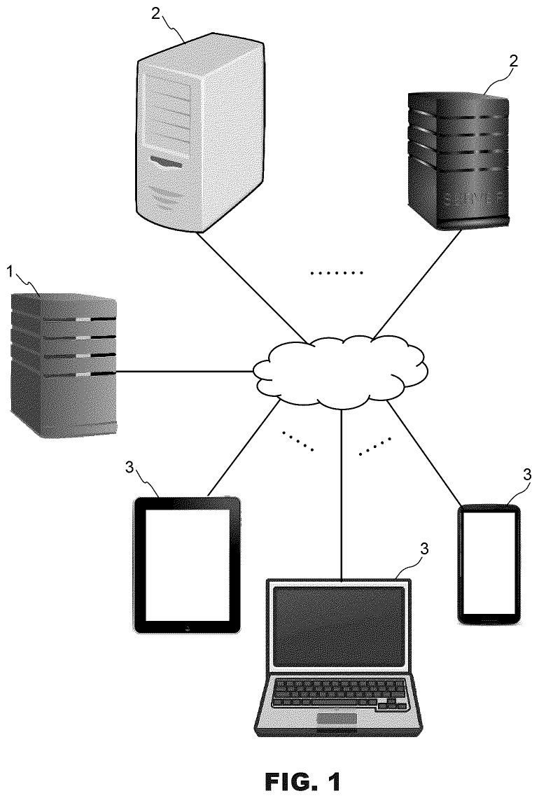

FIG. 1 is a conceptual diagram of a fraud detection system A according to the present embodiment. The fraud detection system A includes a fraud detection apparatus 1, one or more servers 2, and one or more user terminals 3.

The fraud detection apparatus 1 is an apparatus that receives source information from one or two types of apparatuses from among the servers 2 and the user terminals 3, performs fraud detection targeting networks, sites, and IP addresses, using the source information, and outputs the detection results for each. Note that the source information is information that serves as the basis for acquiring information for fraud detection. The source information is typically information formed as a result of an operation performed by a user on a user terminal 3. The source information is typically information formed as a result of a user's user terminal 3 accessing a server 2.

The fraud detection apparatus 1 is typically a server, such as a cloud server or an ASP server, but there is no limitation on the type thereof.

Each server 2 is an apparatus accessed by the user terminals 3. Each server 2 stores, for example, one or more application programs. The application programs are to be installed on the user terminals 3. Each server 2 is, for example, an advertising server that stores one or more pieces of advertising information. Such advertising information is downloaded by the user terminals 3 and output from the user terminals 3. Each server 2 is, for example, a server for an e-commerce site, where users using the user terminals 3 sell products or browse product information. However, there is no limitation on the services that the servers 2 can provide and the information stored in the servers 2.

Each server 2 is, for example, a cloud server or an ASP server, but there is no limitation on the type thereof.

Each user terminal 3 is a terminal used by a user. Each user terminal 3 is a terminal that accesses the servers 2. Each user terminal 3 is, for example, a terminal that accesses an advertising server, an e-commerce site, or the like. Each user terminal 3 is, for example, a terminal on which application programs are to be installed.

Each user terminal 3 is, for example, a so-called personal computer, a tablet terminal, a smartphone, a watch type terminal, or the like, and there is no limitation on the type thereof.

The fraud detection apparatus 1 and each of the one or more servers 2, the fraud detection apparatus 1 and each of the one or more user terminals 3, and each of the one or more servers 2 and each of the one or more user terminals 3 are typically capable of communicating with each other via the Internet, LAN, or the like.

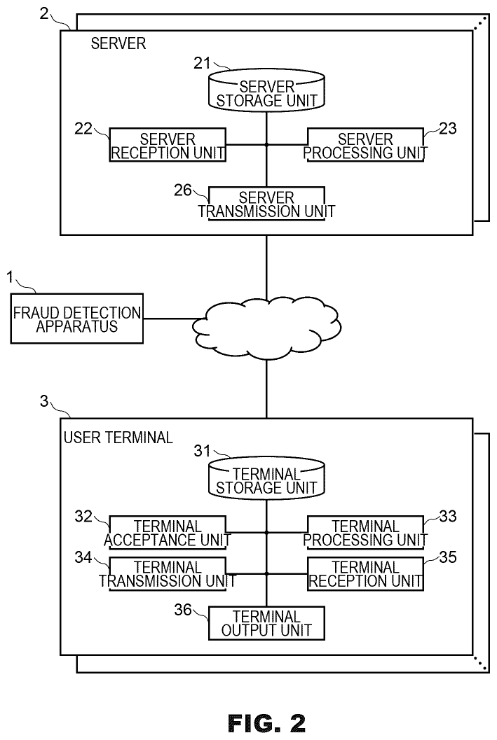

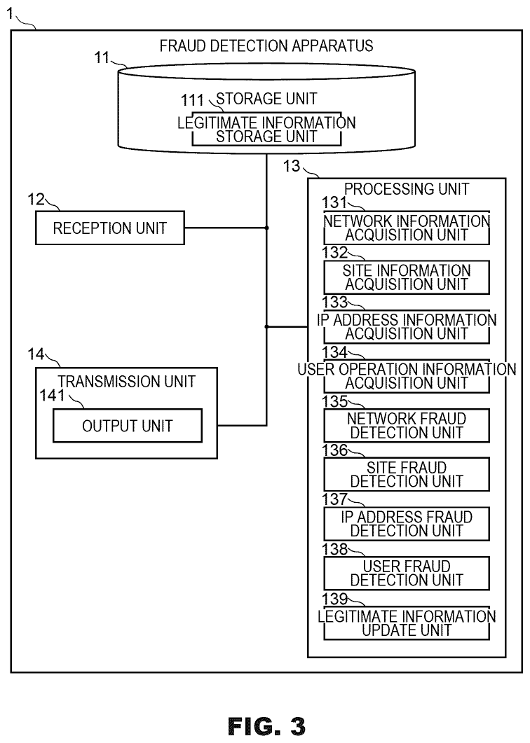

FIG. 2 is a block diagram of the fraud detection system A according to the present embodiment. FIG. 3 is a block diagram of the fraud detection apparatus 1.

The fraud detection apparatus 1 includes a storage unit 11, a reception unit 12, a processing unit 13, and a transmission unit 14. The storage unit 11 includes a legitimate information storage unit 111. The processing unit 13 includes a network information acquisition unit 131, a user operation information acquisition unit 134, an IP address information acquisition unit 133, a user operation information acquisition unit 134, a network fraud detection unit 135, a user fraud detection unit 138, an IP address fraud detection unit 137, a user fraud detection unit 138, and a legitimate information update unit 139. The transmission unit 14 includes an output unit 141.

Each server 2 includes a server storage unit 21, a server reception unit 22, a server processing unit 23, and a server transmission unit 24.

Each user terminal 3 includes a terminal storage unit 31, a terminal acceptance unit 32, a terminal processing unit 33, a terminal transmission unit 34, a terminal reception unit 35, and a terminal output unit 36.

The storage unit 11 included in the fraud detection apparatus 1 stores various kinds of information. Examples of the various types of information include one or more pieces of source information, fraud conditions, network legitimate distribution information, which will be described later, site legitimate distribution information, which will be described later, a frequency condition, and one or more specific tags. Note that the tags are, for example, HTML tags.

The fraud conditions are conditions for detecting the target as fraudulent or conditions for judging that the target is not fraudulent. Examples of fraud conditions include network fraud conditions, site fraud conditions, IP address fraud conditions, and user fraud conditions. Note that the fraud conditions may be embedded in a program.

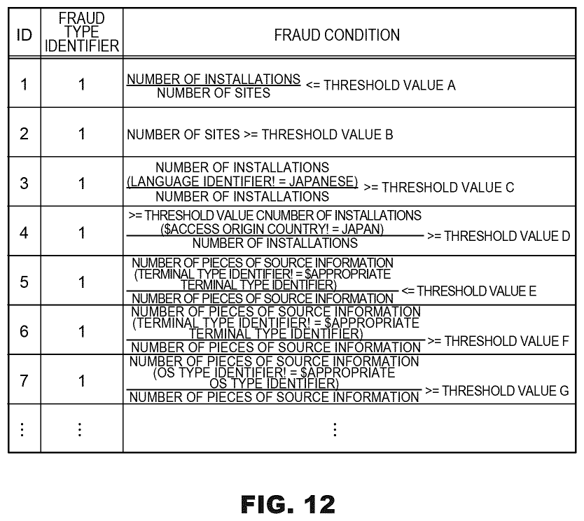

The network fraud conditions are conditions for judging that a network is fraudulent or conditions for judging that a network is not fraudulent. The network fraud conditions are conditions each using one or more network attribute values. Examples of the network attribute values here include the number of application installations, the number of sites belonging to the network, a language identifier, the access origin country of the user terminal 3 accessing the server 2, an operation identifier identifying a user operation, a terminal type identifier identifying the type of user terminal 3, and an OS type identifier identifying the type of OS of the user terminal 3. The network fraud conditions are, for example, the fraud conditions indicated by “ID=1 to 7” in FIG. 12, which will be described later.

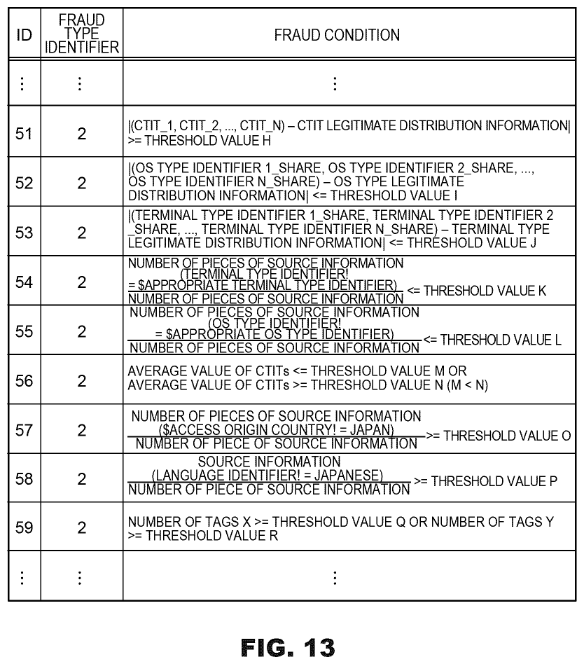

The site fraud conditions are conditions for judging that a site is fraudulent or conditions for judging that a site is not fraudulent. The site fraud conditions are conditions using one or more site attribute values. Examples of the site attribute values here include a CTIT, an OS type identifier, a terminal type identifier, an access origin country, a language identifier, and HTML tags included in webpage information. The site fraud conditions are, for example, the fraud conditions indicated by “ID=51 to 59” in FIG. 13, which will be described later. Note that CTIT stands for “Click to Install Time,” which is the time from a click to installation.

The IP address fraud conditions are conditions for judging that an IP address is fraudulent or conditions for judging that an IP address is not fraudulent. The IP address fraud conditions are conditions each using one or more IP address attribute values. Examples of the IP address attribute values here include a terminal type identifier and a screen size. The IP address fraud conditions are, for example, the fraud conditions indicated by “ID=101 to 103” in FIG. 13, which will be described later.

The user fraud conditions are conditions for judging that a user is fraudulent or conditions for judging that a user is not fraudulent. The user fraud conditions are conditions each using one or more user attribute values. Examples of the user attribute values here include an operation identifier. The IP address fraud conditions are, for example, the fraud conditions indicated by “ID=151 to 152” in FIG. 13, which will be described later.

The frequency condition is a condition regarding the frequency of a specific operation. Examples of the frequency condition include a condition that the proportion of a specific operation is not less than a threshold value or greater than a threshold value, and a condition that the number of specific operations per unit period is not less than a threshold value or greater than a threshold value.

The legitimate information storage unit 111 stores one or more pieces of legitimate distribution information. Legitimate distribution information is information that specifies a legitimate distribution. Legitimate distribution information can typically be expressed as a vector having two or more elements. Examples of the legitimate distribution information include network legitimate distribution information, site legitimate distribution information, and frequency legitimate information.

Network legitimate distribution information is information that specifies legitimate information for network distribution information. Network distribution information is information that specifies the distribution of feature values regarding a network. Network distribution information is, for example, a vector having elements representing the number or proportion of two or more ranges of feature values regarding a network. The feature values regarding a network are network attribute values or information obtained from one or more network attribute values. Example of the feature values regarding a network include the ratio of the number of application downloads to the number of sites belonging to the network.

Site legitimate distribution information is information that specifies legitimate information for site distribution information. Site distribution information is information that specifies the distribution of feature values regarding a site. Site distribution information is, for example, a vector having elements representing the number or proportion of two or more ranges of feature values regarding a site. The feature values regarding a site are site attribute values or information obtained from one or more site attribute values. Examples of the feature values regarding a site include a CTIT, the share of each of the OS type identifiers of the user terminals 3 from which the site is accessed, the share of each of the terminal type identifiers representing the types of the user terminals 3 from which the site is accessed, the share of each of the providers from which the site is accessed, and the share of each of the regions from which the site is accessed. Site distribution information includes any of the following: information regarding the distribution of CTITs, information regarding the distribution of OS type identifiers representing the share of each of the OS types (e.g., OS name and version) of the user terminals 3 from which the site is accessed, information regarding the distribution of user terminal shares representing the share of each of the types of the user terminals 3 from which the site is accessed, information regarding the distribution of provider shares representing the share of each of the provider types of the providers from which the site is accessed, and information regarding the distribution of regional shares representing the share of each of the regions from which the site is accessed.

Legitimate information regarding the distribution of CTITs is referred to as CTIT legitimate distribution information. The structure of CTIT legitimate distribution information is, for example, (the number of pieces of source information with “CTIT<=1 second”, the number of pieces of source information with “1 second<CTIT<=2 seconds”, . . . , the number of pieces of source information with “N seconds<CTIT”), (the proportion of pieces of source information with “CTIT<=1 second”, the proportion of pieces of source information with “1 second <CTIT<=2 seconds”, . . . , the proportion of pieces of source information with “N seconds<CTIT”), (average value, median value, standard deviation, minimum value, maximum value).

Legitimate information regarding the distribution of OS type identifiers is referred to as OS type legitimate distribution information. The structure of OS type legitimate distribution information is, for example, (the proportion of iOS 14.7, the proportion of iOS 15.0, . . . , the proportion of iOS 14.3).

Information regarding the distribution of user terminal shares is referred to as terminal type legitimate distribution information. The structure of terminal type legitimate distribution information is, for example, (the proportion of terminal type identifier 1, the proportion of terminal type identifier 2, . . . , the proportion of terminal type identifier N).

Frequency legitimate information is information indicating the legitimate frequency of operation information indicating a specific operation. The frequency is, for example, the number per unit period, proportion, or count. Operation information indicating a specific operation is, for example, information indicating the pressing of a specific button, information indicating the purchase of a specific product, or information indicating a click on specific advertising information.

The reception unit 12 receives various kinds of information. Examples of the various types of information include source information. The reception unit 12 receives, for example, source information from a server 2. The reception unit 12 receives, for example, source information from a user terminal 3.

Examples of the source information include download information, installation information, user operation information, and webpage information.

Download information is information regarding the fact that a user terminal 3 has downloaded an application from a server 2. Download information contains, for example, an application identifier of the downloaded application, a network identifier, a site identifier, the IP address of the server 2 accessed by the user terminal 3, the IP address of the user terminal 3, fingerprint information, and terminal information.

An application identifier is information that identifies an application, and is, for example, an application ID or an application name.

A network identifier is information that identifies a network, and is, for example, a network ID or a network name. Here, the network identifier is the identifier of the network to which the server 2 belongs.

A site identifier is information that identifies a site, and is, for example, a site ID or a site name. Here, the site identifier is the identifier of the site where the server 2 is present.

Here, the fingerprint information is information that specifies the browser used on the user terminal 3. The fingerprint information is, for example, the ID of the browser.

The terminal information is information regarding the user terminal 3 that accessed the server 2. The terminal information includes, for example, an OS type identifier, a terminal type identifier, a language identifier, and size information.

The OS type identifier is information that specifies the type of OS of the user terminal 3. It is preferable that the OS type identifier also includes the OS version. The OS type identifier is, for example, “iOS”, “Android OS,” or “iOS Ver 14.7”.

The terminal type identifier is information that specifies the type of the user terminal 3. The terminal type identifier is, for example, “personal computer”, “smartphone”, or “tablet”. The terminal type identifier may be a model name.

The language identifier is information that specifies the language set on the user terminal 3, and is, for example, “Japanese”, “English”, or “Chinese”.

The size information is information that specifies the screen size of the user terminal 3. The size information is, for example, (vertical size, horizontal size).

The installation information is information regarding the fact that an application has been installed in the user terminal 3. The installation information contains, for example, an application identifier, a network identifier, a site identifier, an IP address, fingerprint information, terminal information, and a CTIT. The application identifier is the identifier of the installed application.

The user operation information is information regarding operations on the server 2. The user operation information may be considered to include information regarding operations related to application downloads and information regarding operations related to application installations. The user operation information includes operation information that specifies the operations performed by the user. The user operation information contains, for example, operation information, a network identifier, a site identifier, an IP address, fingerprint information, and terminal information.

The operation information contains, for example, a button identifier of the pressed button, information indicating that a product was purchased, information indicating that a product was added to the cart, and a purchase amount.

The webpage information is information regarding a webpage. Webpage information is, for example, a webpage file. The webpage is, for example, written in HTML or XML.

The processing unit 13 performs various kinds of processing. The various kinds of processing are, for example, processing performed by the network information acquisition unit 131, the user operation information acquisition unit 134, the IP address information acquisition unit 133, the user operation information acquisition unit 134, the network fraud detection unit 135, the user fraud detection unit 138, the IP address fraud detection unit 137, the user fraud detection unit 138, and the legitimate information update unit 139.

The network information acquisition unit 131 acquires network information. The network information acquisition unit 131 typically acquires network information from the source information received by the reception unit 12. The network information acquisition unit 131 acquires, for each network identifier, network information from one or more pieces of source information each containing a network identifier.

The network information is information regarding a network including one or more sites. The network information includes one or more network attribute values. Examples of the network attribute values include the number of application downloads, the number of sites belonging to a network, the number of accesses from user terminals 3 with a non-Japanese language setting, the number of application installations from user terminals 3 with a non-Japanese language setting, the number of accesses from user terminals 3 with non-Japan access origins, the number of application installations from user terminals 3 with non-Japan access origins, the number of operation identifiers corresponding to CV operations, the number of accesses from user terminals 3 of types identified by terminal type identifiers that satisfy predetermined conditions (e.g., specific old terminals), and the number of accesses from user terminals 3 equipped with OS types identified by OS type identifiers that satisfy predetermined conditions (e.g., specific old OS). The number of application downloads may be the total number of downloads of two or more applications or the number of downloads of one specific application. Examples of the CV operations include a product purchase operation, a membership registration operation, a document request operation, and an application installation operation.

The network information acquisition unit 131 acquires, for example, two or more network attribute values including the number of application downloads on each of the one or more networks and the number of sites belonging to each network, using one or more pieces of download information received by the reception unit 12.

For example, the network information acquisition unit 131 performs, for each of one or more network identifiers, unique processing on site identifiers paired with the network identifiers, to acquire the number of site identifiers, from two or more pieces of download information each containing a network identifier and a site identifier, the number of site identifiers.

For example, the network information acquisition unit 131 acquires one or more network attribute values that are feature values regarding each of one or more networks. Example of the feature values regarding a network include the ratio of the number of application downloads to the number of sites belonging to the network.

For example, the network information acquisition unit 131 acquires network attribute values that are network distribution information regarding the distribution of feature values of each network. Network distribution information is, for example, information regarding the distribution of CTITs paired with a network identifier.

The site information acquisition unit 132 acquires site information. The site information acquisition unit 132 typically acquires site information from the source information received by the reception unit 12. The site information acquisition unit 132 acquires, for each site identifier, site information from one or more pieces of source information each containing a site identifier. Note that site information is information regarding a site. Each piece of site information typically contains one or more site attribute values.

For example, the site information acquisition unit 132 acquires one or more site attribute values that are feature values of each of one or more sites and acquires site distribution information regarding the distribution of the one or more site attribute values for each site.

The one or more site attribute values include, for example, at least one of the following: a CTIT, an OS share representing the share of each OS type identifier of user terminals 3 from which the site is accessed, and a user terminal share representing the share of each terminal type identifier of user terminals 3 from which the site is accessed.

The site information acquisition unit 132 acquires, for example, the number of tags for each of one or more specific types of tags from webpage information used in the description of a site.

It is preferable that the site information acquisition unit 132 acquires site information for each of two or more sites.

The IP address information acquisition unit 133 acquires IP address information. The IP address information acquisition unit 133 typically acquires IP address information from the source information received by the reception unit 12. The IP address information acquisition unit 133 acquires, for each IP address, IP address information from one or more pieces of source information each containing an IP address. The IP address information is information regarding an IP address. Each piece of IP address information typically contains one or more IP address attribute values. Examples of the IP address attribute values include terminal information and type-specific access counts.

The type-specific access counts are the respective numbers of user terminals 3 accessing an IP address for one or more user terminal types. Each type-specific access count is associated with a terminal type identifier.

For example, the IP address information acquisition unit 133 acquires one or more IP address attribute values including type-specific access counts, which are the respective numbers of user terminals 3 accessing an IP address for one or more user terminal types.

For example, the IP address information acquisition unit 133 acquires, for an IP address, two or more IP address attribute values including a terminal type identifier specifying the type of the user terminal 3 and size information specifying the screen size of the user terminal 3.

The user operation information acquisition unit 134 acquires user operation information regarding operations performed by a user. The user operation information acquisition unit 134 typically acquires user operation information from source information received by the reception unit 12. The user operation information acquisition unit 134 acquires, for each piece of finger print information, IP address information from one or more pieces of source information each containing fingerprint information.

For example, the user operation information acquisition unit 134 acquires two or more pieces of user operation information paired with each of one or more pieces of fingerprint information.

The network fraud detection unit 135 performs fraud detection targeting each of one or more networks using the network information acquired by the network information acquisition unit 131 to acquire a network detection result for each network. Note that the network information contains one or more network attribute values.

For example, the network fraud detection unit 135 acquires the network distribution information acquired by the network information acquisition unit 131 and acquires a network detection result using the network distribution information.

The network detection result is the result of detecting fraud regarding a network. A network detection result includes, for example, “1” indicating that the network is fraudulent or “0” indicating that the network is not fraudulent.

The network fraud detection unit 135 acquires, for example, network distribution difference information regarding the difference between the network distribution information acquired by the network information acquisition unit 131 and the network legitimate distribution information in the legitimate information storage unit 111 and acquires a network detection result using the network distribution difference information. When the network distribution difference information indicates a significant difference, the network fraud detection unit 135 acquires a network detection result indicating that the network is fraudulent. For example, the network distribution difference information indicates a significant difference when it is not less than a predetermined value or greater than a predetermined value. Network distribution difference information is, for example, the distance between a vector representing the network distribution information acquired by the network information acquisition unit 131 and a vector representing the network legitimate distribution information.

For example, the network fraud detection unit 135 calculates, the ratio (D/S) of the number of application downloads (D) in a network to the number of sites(S) belonging to the network and acquires a network detection result indicating that the network is fraudulent when the ratio is not greater than a threshold value or less than a threshold value.

The site fraud detection unit 136 performs, for each of one or more sites, fraud detection targeting the site, using the site information acquired by the user operation information acquisition unit 134, to acquire a site detection result.

The site detection result is information indicating the result of detecting fraud regarding a site. The site detection result includes, for example, “1” indicating that the site is fraudulent or “0” indicating that the site is not fraudulent.

For example, the site fraud detection unit 136 performs fraud detection targeting a site using one or more pieces of site distribution information to acquire a site detection result.

For example, the site fraud detection unit 136 acquires site distribution difference information regarding the difference between one or more pieces of site distribution information acquired by the user operation information acquisition unit 134 and the site legitimate distribution information in the legitimate information storage unit 111 and acquires a site detection result using the site distribution difference information. Note that the site distribution difference information is, for example, the distance between a vector representing the site distribution information and a vector representing the site legitimate distribution information.

For example, the site fraud detection unit 136 performs fraud detection targeting a site using the number of tags for each of one or more tag types in the webpage of the site to acquire a site detection result.

For example, the site fraud detection unit 136 judges that a site is fraudulent when the number or proportion of specific tags in the webpage of the site is not less than a threshold value or greater than a threshold value. For example, the site fraud detection unit 136 may judge that a site is fraudulent when the order of two or more types of tags in the site is a predetermined order or differs from a predetermined order.

For example, the site fraud detection unit 136 clusters two or more sites using the number of tags for each of one or more types of tags in each of two or more sites. For example, the site fraud detection unit 136 judges that a site, which has been judged as a non-fraudulent site in the inspection using one or more tag counts, is fraudulent if it belongs to the same class as a site judged as fraudulent in the inspection using two or more tag counts, and acquires a site detection result. Note that, for example, the site fraud detection unit 136 clusters two or more sites using a vector having elements representing two or more tag counts in the webpage of each site. For vector clustering, for example, the K-means method is used, but there is no limitation on the algorithm.

For example, the site fraud detection unit 136 performs a preliminary inspection to judge whether or not each of two or more sites is a candidate for a fraudulent site, using site information, and performs a detailed inspection to judge whether or not each of one or more sites judged as fraudulent in the preliminary inspection is a fraudulent site, using the site information of the one or more sites, to acquire a site detection result. For example, the site fraud detection unit 136 performs a preliminary inspection to judge whether or not the number or proportion of one or more specific tags in the webpage of a site is not less than a threshold value or greater than a threshold value.

The IP address fraud detection unit 137 performs, for each of one or more IP addresses, fraud detection targeting the IP address, using the IP address information acquired by the IP address information acquisition unit 133, to acquire an IP address detection result.

The IP address detection result is information indicating the result of detecting fraud regarding an IP address. For example, the IP address detection result includes “1” indicating that the IP address is fraudulent or “0” indicating that the IP address is not fraudulent.

For example, the IP address fraud detection unit 137 performs fraud detection targeting an IP address, using one or more IP address attribute values, to acquire an IP address detection result.

For example, when the number of pieces of IP address information for which the screen size corresponding to the terminal type identifier included in two or more pieces of IP address information does not match (e.g., is inconsistent with) the screen size indicated by the size information included in the received source information is sufficiently large to satisfy a fraud condition, the IP address fraud detection unit 137 acquires an IP address detection result indicating that the IP address is fraudulent. Note that, for example, the fraud condition is that the proportion of cases where the screen size corresponding to the terminal type identifier does not match the screen size indicated by the size information included in the received source information is not less than or greater than a threshold value. The threshold value is, for example, 95%, but there is no limitation.

The user fraud detection unit 138 performs, for each user, fraud detection targeting the user, using the user operation information acquired by the user operation information acquisition unit 134 to acquire a user detection result. Note that “for each user” typically means “for each piece of fingerprint information”.

The user detection result is information indicating the result of detecting fraud regarding a user. For example, the user detection result includes “1” indicating that the user is fraudulent or “0” indicating that the user is not fraudulent.

For example, the user fraud detection unit 138 acquires a user detection result indicating that the user is fraudulent when the two or more pieces of user operation information include a large number of pieces of operation information indicating a specific operation, the large number being sufficiently large to satisfy the frequency condition.

For example, the user fraud detection unit 138 acquires a user detection result indicating that a user is fraudulent when two or more pieces of user operation information include a large number of pieces of frequency information of operation information indicating a specific operation, the large number being sufficiently large to satisfy the frequency condition relative to one or more pieces of frequency information of other users and relative to a baseline.

The legitimate information update unit 139 updates one or more pieces of legitimate distribution information. For example, the legitimate distribution information is network legitimate distribution information or site legitimate distribution information, but there is no limitation. For example, the legitimate information update unit 139 updates legitimate distribution information when predetermined update conditions are satisfied. For example, the update conditions include reaching a predetermined time or newly receiving a predetermined number of pieces of source information.

For example, the legitimate information update unit 139 forms new legitimate distribution information using multiple pieces of source information to be processed and accumulates the legitimate distribution information in the legitimate information storage unit 111. Such accumulation is an update of the legitimate distribution information. For example, the multiple pieces of source information to be processed are newly received source information or received legitimate source information.

For example, the legitimate information update unit 139 acquires a CTIT from each of multiple pieces of source information to be processed, acquires the number or proportion corresponding to each of two or more CTIT ranges, forms legitimate distribution information as a vector having elements representing each number or proportion, and accumulates the vector in the legitimate information storage unit 111. Note that the legitimate distribution information here is, for example, site legitimate distribution information.

For example, the legitimate information update unit 139 acquires an OS type identifier from each of multiple pieces of source information to be processed, acquires the appearance count of each of two or more OS type identifiers, forms legitimate distribution information as a vector having elements representing each appearance count, and accumulates the vector in the legitimate information storage unit 111. Note that the legitimate distribution information here is, for example, site legitimate distribution information.

For example, the legitimate information update unit 139 acquires a terminal type identifier from each of multiple pieces of source information to be processed, acquires the appearance count of each of two or more terminal type identifiers, forms legitimate distribution information as a vector having elements representing each appearance count, and accumulates the vector in the legitimate information storage unit 111. Note that the legitimate distribution information here is, for example, site legitimate distribution information.

The transmission unit 14 outputs various kinds of information. Examples of the various kinds of information include detection results. The detection results include a network detection result, a site detection result, an IP address detection result, or a user detection result. For example, the transmission unit 14 transmits various kinds of information to a management terminal (not shown).

The output unit 141 outputs the network detection result, the site detection result, and the IP address detection result. It is preferable that the output unit 141 also outputs the user detection result.

Here, “output” is typically transmission to an external apparatus, but may be a concept that encompasses displaying on a display screen, projection using a projector, printing by a printer, the output of a sound, accumulation on a recording medium, delivery of a processing result to another processing apparatus or another program, and so on.

The server storage unit 21 included in each server 2 stores various kinds of information. Examples of the various kinds of information include application programs, webpage information, advertising information, and transmission conditions. Note that webpage information includes, for example, a script embedded for the user terminals 3 to form source information and transmit it to the fraud detection apparatus 1. For example, the script is JavaScript (registered trademark).

The transmission conditions are conditions for transmitting source information to the fraud detection apparatus 1. For example, the transmission conditions are information specifying instructions or information received by the server reception unit 22 from a user terminal 3. Examples of transmission conditions include a condition that the instructions or information received by the server reception unit 22 includes a download instruction “download*” and a condition that the instructions or information received by the server reception unit 22 includes “button_click specific button identifier” indicating the pressing of a specific button.

The server reception unit 22 receives various kinds of instructions or information from the user terminals 3. Examples of the various kinds of instructions and information include a download instruction and user operation information.

The server processing unit 23 performs various kinds of processing. The server processing unit 23 performs processing corresponding to instructions or information received from the user terminals 3. For example, the server processing unit 23 acquires an application program corresponding to a received download instruction from the server storage unit 21. For example, the server processing unit 23 performs payment processing in response to a purchase instruction included in received user operation information.

When the server reception unit 22 receives various kinds of instructions or information, the server processing unit 23 forms source information corresponding to the instructions or information.

For example, the server processing unit 23 judges whether or not the received instructions or information match the transmission conditions. Thereafter, for example, the server processing unit 23 forms source information corresponding to the received instructions or information only when it is judged that the transmission conditions are met.

The server processing unit 23 may form source information using the received instructions or information without judging whether or not the transmission conditions are met.

The server transmission unit 24 transmits various kinds of information. For example, the server transmission unit 24 transmits source information formed by the server processing unit 23 to the fraud detection apparatus 1.

For example, the server transmission unit 24 transmits an application program acquired by the server processing unit 23 to a user terminal 3.

For example, the server transmission unit 24 transmits information regarding the result of processing performed by the server processing unit 23 corresponding to user operation information to a user terminal 3.

The terminal storage unit 31 included in each user terminal 3 stores various kinds of information. Examples of the various kinds of information include a user identifier, source information, and transmission conditions.

The transmission conditions are conditions for transmitting source information to the fraud detection apparatus 1. Examples of transmission conditions include information specifying instructions or information received by the terminal acceptance unit 32 or information specifying processing results corresponding to instructions or information received by the terminal acceptance unit 32. Examples of transmission conditions include a condition that the instructions or information received by the terminal acceptance unit 32 include an installation instruction “install *” and a condition that the instructions or information received by the terminal acceptance unit 32 include “button_click specific button identifier” indicating the pressing of a specific button.

The terminal acceptance unit 32 accepts various kinds of instructions and information. Examples of the various kinds of instructions and information include a download instruction, an installation instruction, and operation information.

Any input means, such as a touch panel, a keyboard, a mouse, a menu screen, or the like, may be employed to input the various kinds of instructions and information.

The terminal processing unit 33 performs various kinds of processing. Examples of the various types of processing include processing performed to convert instructions or information received by the terminal acceptance unit 32 into instructions or information in a structure for transmission, and processing performed to convert information received by the terminal reception unit 35 into a structure for output, and so on.

The terminal processing unit 33 forms source information corresponding to various kinds of instructions or information accepted by the terminal acceptance unit 32.

The terminal processing unit 33 installs, in response to an installation instruction accepted by the terminal acceptance unit 32, an application program corresponding to the installation instruction.

For example, the terminal processing unit 33 judges whether or not the instructions or information accepted by the terminal acceptance unit 32 or the processing results corresponding to the instructions or information accepted by the terminal acceptance unit 32 match the transmission conditions. For example, the terminal processing unit 33 forms source information using the instructions or information accepted by the terminal acceptance unit 32 or the processing results corresponding to the instructions or information accepted by the terminal acceptance unit 32 only when it is judged that the transmission conditions are met. Note that the terminal processing unit 33 may form source information using the instructions or information accepted by the terminal acceptance unit 32 or the processing results corresponding to the instructions or information accepted by the terminal acceptance unit 32 without judging whether or not the transmission conditions are met.

The terminal transmission unit 34 transmits various kinds of instructions and information. The terminal transmission unit 34 transmits, for example, a download instruction and operation information to a server 2. For example, the terminal transmission unit 34 transmits source information formed by the terminal processing unit 33 to the fraud detection apparatus 1.

The terminal reception unit 35 receives various kinds of information. Examples of the various types of information include an application program and information indicating the result of transmitting operation information.

The terminal output unit 36 outputs various kinds of information. Examples of the various kinds of information include information indicating the result of transmitting user operation information.

Here, “output” is a concept that encompasses displaying on a display screen, projection using a projector, printing by a printer, the output of a sound, transmission to an external apparatus, accumulation on a recording medium, delivery of a processing result to another processing apparatus or another program, and so on.

The storage unit 11, the legitimate information storage unit 111, the server storage unit 21, and the terminal storage unit 31 are preferably non-volatile recording media, but they can be realized using volatile recording media.

There is no limitation on the process in which information is stored in the storage unit 11 or the like. For example, information may be stored in the storage unit 11 or the like via a recording medium, or information transmitted via a communication line or the like may be stored in the storage unit 11 or the like, or information input via an input device may be stored in the storage unit 11 or the like.

The reception unit 12, the server reception unit 22, and the terminal reception unit 35 are typically realized using wireless or wired communication means, but they may also be realized using broadcast receiving means.

The processing unit 13, the network information acquisition unit 131, the user operation information acquisition unit 134, the IP address information acquisition unit 133, the user operation information acquisition unit 134, the network fraud detection unit 135, the user fraud detection unit 138, the IP address fraud detection unit 137, the user fraud detection unit 138, the legitimate information update unit 139, the server processing unit 23, and the processing unit 33 can typically be realized using a processor, a memory, and so on. The processing procedures performed by the processing unit 13 and so on are typically realized using software, and the software is recorded on a recording medium such as a ROM. However, such processing procedures may be realized using hardware (a dedicated circuit). Note that the processor may be a CPU, an MPU, a GPU, or the like, and there is no limitation on the type thereof.

The transmission unit 14, the output unit 141, the server transmission unit 24, and the terminal transmission unit 34 are typically realized using wireless or wired communication means, but they may also be realized using broadcasting means.

The terminal acceptance unit 32 can be realized using a device driver for input means such as a touch panel or a keyboard, control software for a menu screen, or the like.

The terminal output unit 36 may be regarded as including or not including an output device such as a display or a speaker. The terminal output unit 36 can be realized using the driver software of the output device, the driver software of the output device and the output device, or the like.

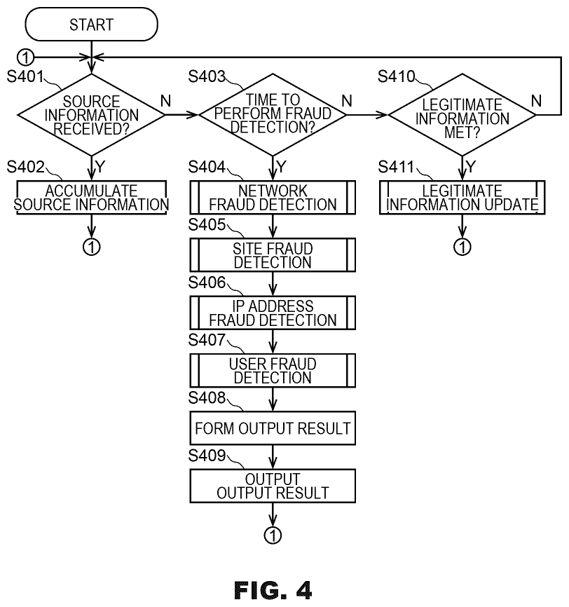

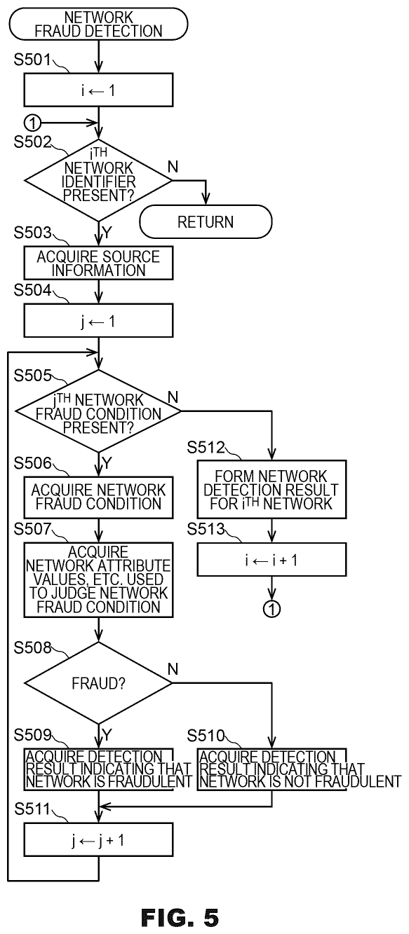

Next, an example of operation of the fraud detection system A will be described. First, an example of operation of the fraud detection apparatus 1 will be described with reference to the flowchart in FIG. 4.

(Step S401) The reception unit 12 judges whether or not source information has been received from a server 2 or a user terminal 3. If source information has been received, processing proceeds to step S402, and if source information has not been received, processing proceeds to step S403.

(Step S402) The processing unit 13 accumulates the source information received in step S401 in the storage unit 11. Processing returns to step S401.

(Step S403) The processing unit 13 judges whether or not it is time to perform fraud detection. If it is time to perform fraud detection, processing proceeds to step S404, and if it is not time to perform fraud detection, processing returns to step S401.

The time to perform fraud detection may be, for example, when a predetermined time is reached, when the reception unit 12 receives a fraud detection instruction, or when a number of pieces of source information equal to or greater than a threshold value have been accumulated.

(Step S404) The network fraud detection unit 135 and so on perform network fraud processing. An example of network fraud processing will be described with reference to the flowchart in FIG. 5.

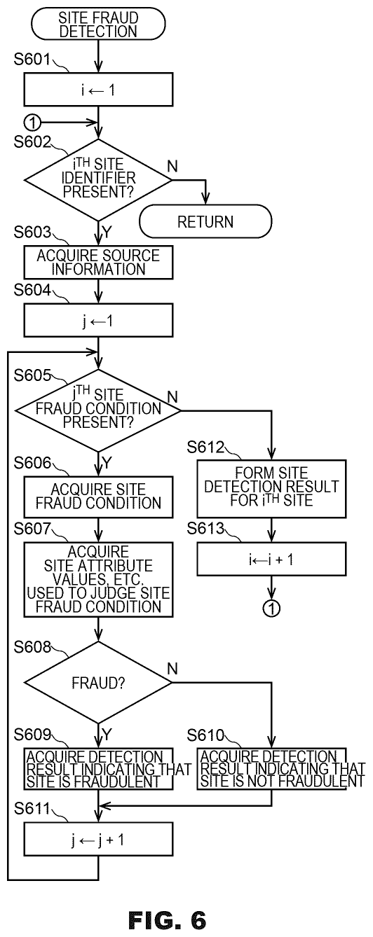

(Step S405) The user fraud detection unit 138 and so on perform site fraud processing. An example of site fraud processing will be described with reference to the flowchart in FIG. 6.

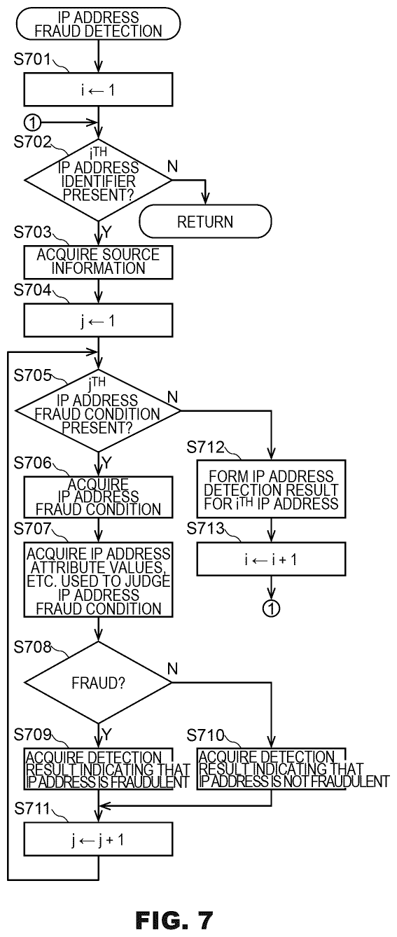

(Step S406) The IP address fraud detection unit 137 and so on perform IP address fraud processing. An example of IP address fraud processing will be described with reference to the flowchart in FIG. 7.

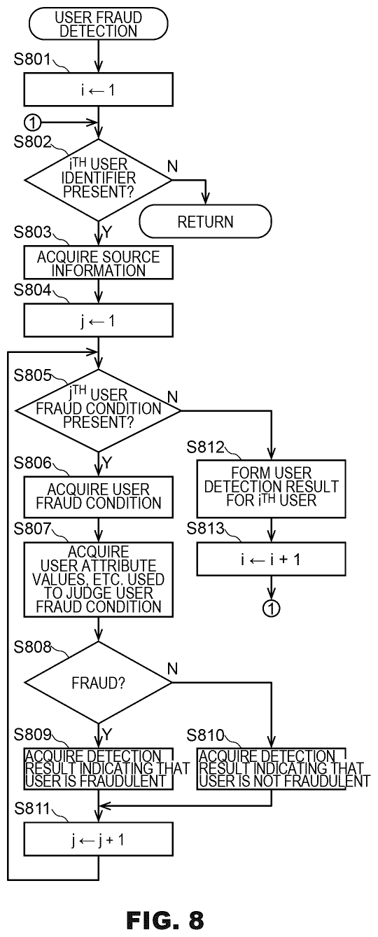

(Step S407) The user fraud detection unit 138 and so on perform user fraud processing. An example of user fraud processing will be described with reference to the flowchart in FIG. 8.

(Step S408) The processing unit 13 forms an output result using the results of the fraud detection processing from step S404 to step S407.

(Step S409) The output unit 141 outputs the output result formed in step S408. Processing returns to step S401. Note that “output” here is, for example, accumulation on a recording medium or transmission to an external apparatus, but it may also include concepts such as delivery of a processing result to another processing apparatus or another program, displaying on a display screen, projection using a projector, printing by a printer, the output of a sound, and so on.

(Step S410) The processing unit 13 judges whether or not update conditions for legitimate information are met. If the update conditions are met, processing proceeds to step S411, and if the update conditions are not met, processing returns to step S401.

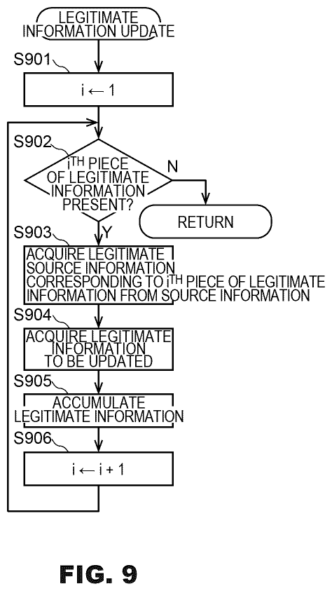

(Step S411) The legitimate information update unit 139 performs legitimate information update processing. Processing returns to step S401. An example of legitimate information update processing will be described with reference to the flowchart in FIG. 9.

In the flowchart shown in FIG. 4, processing is terminated when power is turned off or an interruption is made to terminate the processing.

Next, an example of the network fraud processing in step S404 will be described with reference to the flowchart in FIG. 5.

(Step S501) The network information acquisition unit 131 assigns 1 to a counter i.

(Step S502) The network information acquisition unit 131 judges whether or not an i^{th} network identifier is present. If the i^{th} network identifier is present, processing proceeds to step S503, and if the i^{th} network identifier is not present, processing returns to the higher level processing.

(Step S503) The network information acquisition unit 131 acquires one or more pieces of source information each including the i^{th} network identifier from among the pieces of source information to be subjected to fraud detection processing, from the storage unit 11.

(Step S504) The network fraud detection unit 135 assigns 1 to a counter j.

(Step S505) The network fraud detection unit 135 judges whether or not a j^{th} network fraud condition is present. If the j^{th} network fraud condition is present, processing proceeds to step S506, and if the j^{th} network fraud condition is not present, processing proceeds to step S512.

(Step S506) The network fraud detection unit 135 acquires the j^{th} network fraud condition from the storage unit 11.

(Step S507) The network information acquisition unit 131 acquires one or more pieces of information used to judge the j^{th} network fraud condition. Each of the one or more pieces of information is a network attribute value or a network feature value.

(Step S508) The network fraud detection unit 135 judges whether or not the one or more pieces of information acquired in Step S507 satisfy the j^{th} network fraud condition. If the j^{th} network fraud condition is satisfied (here, if it indicates that the network is fraudulent), processing proceeds to step S509, and otherwise processing proceeds to step S510.

(Step S509) The network fraud detection unit 135 acquires a network detection result indicating that the network is fraudulent, in association with the i^{th} network identifier and the j^{th} network fraud condition, and temporarily accumulates it in a buffer (not shown). Processing proceeds to step S511.

(Step S510) The network fraud detection unit 135 acquires a network detection result indicating that the network is not fraudulent, in association with the i^{th} network identifier and the j^{th} network fraud condition, and temporarily accumulates it in the buffer (not shown).

(Step S511) The network fraud detection unit 135 increments the counter j by one. Processing returns to Step S505.

(Step S512) The network fraud detection unit 135 forms a final network detection result associated with the i^{th} network identifier using the network detection results stored in the buffer (not shown).

(Step S513) The network information acquisition unit 131 increments the counter i by one. Processing returns to step S502.

Next, an example of the site fraud processing in step S405 will be described with reference to the flowchart in FIG. 6.

(Step S601) The site information acquisition unit 132 assigns 1 to a counter i.

(Step S602) The site information acquisition unit 132 judges whether or not an i^{th} site identifier is present. If the i^{th} site identifier is present, processing proceeds to step S603, and if the i^{th} site identifier is not present, processing returns to the higher level processing.

(Step S603) The site information acquisition unit 132 acquires one or more pieces of source information each including the i^{th} site identifier from among the pieces of source information to be subjected to fraud detection processing, from the storage unit 11.

(Step S604) The site fraud detection unit 136 assigns 1 to a counter j.

(Step S605) The site fraud detection unit 136 judges whether or not the j^{th} site fraud condition is present. If the j^{th} site fraud condition is present, processing proceeds to step S606, and if the j^{th} site fraud condition is not present, processing proceeds to step S612.

(Step S606) The site fraud detection unit 136 acquires the j^{th} site fraud condition from the storage unit 11.

(Step S607) The site information acquisition unit 132 acquires one or more pieces of information used to judge the j^{th} site fraud condition. Each of the one or more pieces of information is a site attribute value or a site feature value.

(Step S608) The site fraud detection unit 136 judges whether the one or more pieces of information acquired in step S607 satisfy the j^{th} site fraud condition. If the j^{th} site fraud condition is satisfied, processing proceeds to step S609, and otherwise processing proceeds to step S610.

(Step S609) The site fraud detection unit 136 acquires a site detection result indicating that the site is fraudulent, in association with the i^{th} site identifier and the j^{th} site fraud condition, and temporarily accumulates it in the buffer (not shown). Processing proceeds to step S611.

(Step S610) The site fraud detection unit 136 acquires a site detection result indicating that the site is not fraudulent, in association with the i^{th} site identifier and the j^{th} site fraud condition, and temporarily accumulates it in the buffer (not shown).

(Step S611) The site fraud detection unit 136 increments the counter j by one. Processing returns to step S605.

(Step S612) The site fraud detection unit 136 forms the final site detection result associated with the i^{th} site identifier using the site detection results stored in the buffer (not shown).

(Step S613) The site information acquisition unit 132 increments the counter i by one. Processing returns to step S602.

Next, an example of the IP address fraud processing in step S406 will be described with reference to the flowchart in FIG. 7.

(Step S701) The IP address information acquisition unit 133 assigns 1 to a counter i.

(Step S702) The IP address information acquisition unit 133 judges whether or not an i^{th} IP address identifier is present. If the i^{th} IP address identifier is present, processing proceeds to step S703, and if the i^{th} IP address identifier is not present, the higher level processing. Note that the IP address identifiers may be IP addresses.

(Step S703) The IP address information acquisition unit 133 acquires one or more pieces of source information each including the i^{th} IP address identifier from among the pieces of source information to be subjected to fraud detection processing, from the storage unit 11.

(Step S704) The IP address fraud detection unit 137 assigns 1 to a counter j.

(Step S705) The IP address fraud detection unit 137 judges whether or not a j^{th} IP address fraud condition is present. If the j^{th} IP address fraud condition is present, processing proceeds to step S706, and if the j^{th} IP address fraud condition is not present, processing proceeds to step S712.

(Step S706) The IP address fraud detection unit 137 acquires the j^{th} IP address fraud condition from the storage unit 11.

(Step S707) The IP address information acquisition unit 133 acquires one or more pieces of information used to judge the j^{th} IP address fraud condition. Each of the one or more pieces of information is an IP address attribute value or an IP address feature value.

(Step S708) The IP address fraud detection unit 137 judges whether or not the one or more pieces of information acquired in step S707 satisfy the j^{th} IP address fraud condition. If the j^{th} IP address fraud condition is satisfied, processing proceeds to step S709, and otherwise processing proceeds to step S710.

(Step S709) The IP address fraud detection unit 137 acquires an IP address detection result indicating that the IP address is fraudulent, in association with the i^{th} IP address identifier and the j^{th} IP address fraud condition, and temporarily accumulates it in the buffer (not shown). Processing proceeds to step S711.

(Step S710) The IP address fraud detection unit 137 acquires an IP address detection result indicating that the IP address is not fraudulent, in association with the i^{th} IP address identifier and the j^{th} IP address fraud condition, and temporarily accumulates it in the buffer (not shown).

(Step S711) The IP address fraud detection unit 137 increments the counter j by one. Processing returns to step S705.

(Step S712) The IP address fraud detection unit 137 forms the final IP address detection result associated with the i^{th} IP address identifier using the IP address detection results stored in the buffer (not shown).

(Step S713) The IP address information acquisition unit 133 increments the counter i by one. Processing returns to step S702.

Next, an example of the user fraud processing in step S407 will be described with reference to the flowchart in FIG. 8.

(Step S801) The user operation information acquisition unit 134 assigns 1 to a counter i.

(Step S802) The user operation information acquisition unit 134 judges whether or not an i^{th} user identifier is present. If the i^{th} user identifier is present, processing proceeds to step S803, and if the i^{th} user identifier is not present, processing returns to the higher level processing. Note that the user identifier here is typically fingerprint information.

(Step S803) The user operation information acquisition unit 134 acquires one or more pieces of source information each including the i^{th} user identifier from among the pieces of source information to be subjected to fraud detection processing, from the storage unit 11.

(Step S804) The user fraud detection unit 138 assigns 1 to a counter j.

(Step S805) The user fraud detection unit 138 judges whether or not the a j^{th} user fraud condition is present. If the j^{th} user fraud condition is present, processing proceeds to step S806, and if the j^{th} user fraud condition is not present, processing proceeds to step S812.

(Step S806) The user fraud detection unit 138 acquires the j^{th} user fraud condition from the storage unit 11.

(Step S807) The user operation information acquisition unit 134 acquires one or more pieces of information used to judge the j^{th} user fraud condition. Each of the one or more pieces of information is a user attribute value or a user feature value.

(Step S808) The user fraud detection unit 138 judges whether or not the one or more pieces of information acquired in step S807 satisfy the j^{th} user fraud condition. If the j^{th} user fraud condition is satisfied, processing proceeds to step S809, and if the j^{th} user fraud condition is not satisfied, processing proceeds to step S810.

(Step S809) The user fraud detection unit 138 acquires a user detection result indicating that the user is fraudulent, in association with the i^{th} user identifier and the j^{th} user fraud condition, and temporarily accumulates it in the buffer (not shown). Processing proceeds to step S811.

(Step S810) The user fraud detection unit 138 acquires a user detection result indicating that the user is not fraudulent, in association with the i^{th} user identifier and the j^{th} user fraud condition, and temporarily accumulates it in the buffer (not shown).

(Step S811) The user fraud detection unit 138 increments the counter j by one. Processing returns to step S805.

(Step S812) The user fraud detection unit 138 forms the final user detection result associated with the i^{th} user identifier using the user detection results stored in the buffer (not shown).

(Step S813) The user operation information acquisition unit 134 increments the counter i by one. Processing returns to step S802.

Next, an example of the legitimate information update processing in step S411 will be described with reference to the flowchart in FIG. 9.

(Step S901) The legitimate information update unit 139 assigns 1 to a counter i.

(Step S902) The legitimate information update unit 139 judges whether or not an i^{th} piece of legitimate distribution information to be updated is present. If the i^{th} piece of legitimate distribution information is present, processing proceeds to step S903, and if the i^{th} piece of legitimate distribution information is not present, processing returns to the higher level processing.

(Step S903) The legitimate information update unit 139 acquires legitimate source information, which is information used to form the i^{th} piece of legitimate distribution information, from the source information to be processed in the storage unit 11. Note that the legitimate source information is, for example, a CTIT, an OS type identifier, a terminal type identifier, or specific operation information (e.g., “download” or “operation information indicating purchase”).

(Step S904) The legitimate information update unit 139 forms the legitimate distribution information to be updated using the legitimate source information acquired in step S903.

(Step S905) The legitimate information update unit 139 overwrites the information in the legitimate information storage unit 111 with the legitimate distribution information formed in step S904.

(Step S906) The legitimate information update unit 139 increments the counter i by one. Processing returns to step S902.

Next, an example of operation of each server 2 will be described with reference to the flowchart in FIG. 10.

(Step S1001) The server reception unit 22 judges whether or not an instruction or information has been received from a user terminal 3. If an instruction or information has been received, processing proceeds to step S1002, and otherwise processing returns to step S1001.

(Step S1002) The server processing unit 23 performs processing according to the instruction or information received in step S1001.

(Step S1003) The server processing unit 23 judges whether or not the instruction or information received in step S1001 match the transmission conditions in the server storage unit 21. If the transmission conditions are met, processing proceeds to step S1004, and otherwise processing returns to step S1001.

(Step S1004) The server processing unit 23 acquires fingerprint information of the user terminal 3 that accessed the server 2.

(Step S1005) The server processing unit 23 acquires the IP address of the server 2. The server processing unit 23 acquires the IP address of the user terminal 3.

(Step S1006) The server processing unit 23 acquires the site identifier of the server 2.

(Step S1007) The server processing unit 23 acquires the network identifier of the network to which the server 2 belongs.

(Step S1008) The server processing unit 23 acquires information corresponding to the instruction or information received in step S1001 (e.g., “download” or “button_click specific button identifier”).

(Step S1009) The server processing unit 23 forms source information including the information acquired through the processing from step S1004 to step S1008.

(Step S1010) The server transmission unit 24 transmits the source information formed in step S1009 to the fraud detection apparatus 1. Processing returns to step S1001.

In the flowchart in FIG. 10, processing is terminated when power is turned off or an interruption is made to terminate the processing.

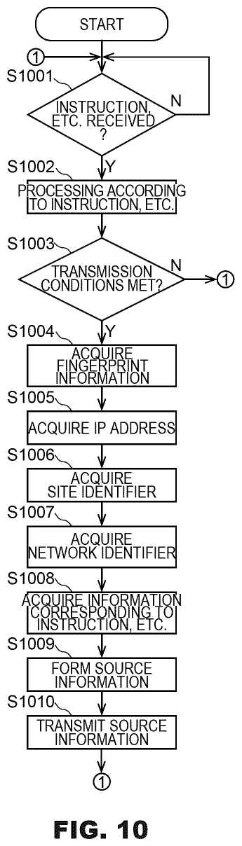

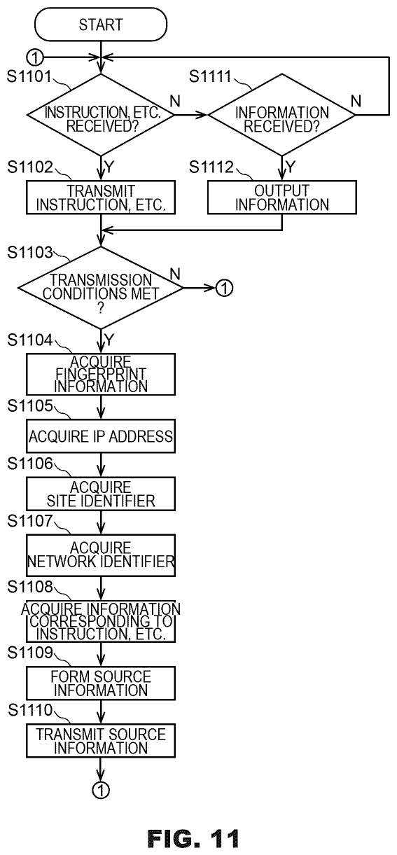

Next, an example of operation of each user terminal 3 will be described with reference to the flowchart in FIG. 11.

(Step S1101) The terminal acceptance unit 32 judges whether or not an instruction or information has been accepted. If an instruction or information has been accepted, processing proceeds to step S1102, and otherwise processing proceeds to step S1111.

(Step S1102) The terminal processing unit 33 forms an instruction or information to be transmitted from the instruction or information accepted in step S1101. The terminal transmission unit 34 transmits the instruction or information to the server 2.

(Step S1103) The terminal processing unit 33 judges whether or not the instruction or information accepted in step S1101 or the information received in step S1111 match the transmission conditions in the terminal storage unit 31. If the transmission conditions are met, processing proceeds to step S1104, and otherwise processing returns to step S1101.

(Step S1104) The terminal processing unit 33 acquires fingerprint information.

(Step S1105) The terminal processing unit 33 acquires the IP address of the server 2 accessed. The server processing unit 23 acquires the IP address of the user terminal 3.

(Step S1106) The terminal processing unit 33 acquires the site identifier of the server 2 accessed.

(Step S1107) The terminal processing unit 33 acquires the network identifier of the network to which the server 2 accessed belongs.

(Step S1108) The terminal processing unit 33 acquires information corresponding to the instruction or information received in step S1101 or the information received in step S1111 used to form source information (e.g., “download” or “button_click specific button identifier”).

(Step S1109) The terminal processing unit 33 forms source information including the information acquired through the processing from step S1104 to step S1108.

(Step S1110) The terminal transmission unit 34 transmits the source information formed in step S1109 to the fraud detection apparatus 1. Processing returns to step S1101.

(Step S1111) The terminal reception unit 35 judges whether or not information has been received from the server 2. If information has been received, processing proceeds to step S1112, and if information has not been received, processing returns to step S1101.

(Step S1112) The terminal processing unit 33 forms information to be output using the received information. The terminal output unit 36 outputs the information. Processing proceeds to step S1103.

In the flowchart in FIG. 11, processing is terminated when power is turned off or an interruption is made to terminate the processing.

Hereinafter, a specific example of operation of the fraud detection system A according to the present embodiment will be described.

Now, the storage unit 11 of the fraud detection apparatus 1 stores a fraud condition management table shown in FIGS. 12 to 14. The fraud condition management table is a table that manages various fraud conditions. The fraud condition management table manages one or more records each having “ID”, “fraud type identifier”, and “fraud condition”. “ID” identifies a record. “Fraud type identifier” is information that identifies the type of fraud. Fraud type identifier “1” indicates network fraud. Fraud type identifier “2” indicates site fraud. Fraud type identifier “3” indicates IP address fraud. Fraud type identifier “4” indicates user fraud. Regarding the various fraud conditions here, meeting a fraud condition indicates fraud, while not meeting a fraud condition indicates no fraud.

The fraud condition indicated by “ID=1” is a condition that the average number of installations per site belonging to a network is less than or equal to a threshold value A (e.g., “threshold value A=2”). The fraud condition indicated by “ID=2” is a condition that the number of sites belonging to a network is greater than or equal to a threshold value B (e.g., “threshold value B=20”). The fraud condition indicated by “ID=3” is a condition that the proportion of installations from user terminals 3 with language settings other than Japanese, relative to the total number of installations when an application program is installed by accessing a site belonging to a network, is greater than or equal to a threshold value C. “!=” is an operator indicating mismatch. The fraud condition indicated by “ID=4” is a condition that the proportion of installations from overseas IPs is greater than or equal to a threshold value D. Note that “$access origin country” is a variable into which the name of the country where the user terminal 3 accessing a site belonging to a network is present, obtained from the IP address of the user terminal 3, is substituted. The storage unit 11 stores a correspondence table including two or more pieces of correspondence information indicating the correspondence between IP address ranges and country names. The network information acquisition unit 131 references the correspondence table, acquires the country name corresponding to the IP address of the user terminal 3 included in the received source information, and substitutes it into “$access origin country”. The fraud condition indicated by “ID=5” is a condition that the number of conversion (CV) operations per site belonging to a network is less than or equal to a threshold value E. Note that the variable “$CV operation” is stored in the storage unit 11, and one or more operation identifiers judged to be conversion operations are stored in advance in the variable “$CV operation”. The fraud condition indicated by “ID=6” is a condition that the proportion of user terminals 3 of an inappropriate type (e.g., old devices) accessing a site belonging to a network is greater than or equal to a threshold value F. The variable “$appropriate terminal type identifier” is stored in the storage unit 11, and one or more appropriate terminal type identifiers (e.g., the type identifiers of new devices) are stored in advance in the variable “$appropriate terminal type identifier”. The fraud condition indicated by “ID=7” is a condition that the proportion of user terminals 3 of an inappropriate OS type (e.g., old OS) accessing a site belonging to a network is greater than or equal to a threshold value G. The variable “$appropriate OS type identifier” is stored in the storage unit 11, and one or more appropriate OS type identifiers (e.g., the type identifiers of new OSs) are stored in advance in the variable “$appropriate OS type identifier”.

The fraud condition indicated by “ID=51” in FIG. 13 is a condition that the absolute value of the difference between the CTIT distribution in a site and the CTIT legitimate distribution information is greater than or equal to a threshold value H. Note that the CTIT legitimate distribution information is, for example, (70000, 20000, . . . , 5000). The difference between these two is, in this case, the distance between two vectors. The fraud condition indicated by “ID=52” is a condition that the absolute value of the difference between the distribution of the OS types of user terminals 3 accessing a site and the OS type legitimate distribution information is greater than or equal to a threshold value I. The OS type legitimate distribution information is, for example, (54.9%, 14.2%, . . . , 2.0%). The fraud condition indicated by “ID=53” is a condition that the absolute value of the difference between the distribution of the types of user terminals 3 accessing a site and the terminal type legitimate distribution information is greater than or equal to a threshold value J. The fraud conditions indicated by “ID=54, 55” are the same as the fraud conditions indicated by “ID=6, 7” except for the source information subjected to fraud judgment, and therefore their descriptions are omitted. The fraud condition indicated by “ID=56” is a condition that the average value of CTITs is excessively small or excessively large. The fraud conditions indicated by “ID=57, 58” are similar to the fraud conditions indicated by “ID=4, 3,”, and therefore their descriptions are omitted. The fraud condition indicated by “ID=59” is a condition that the number of specific “tags X” in the HTML realizing one or more webpages in a site is greater than or equal to a threshold value Q, or the number of specific “tags Y” is greater than or equal to a threshold value R.

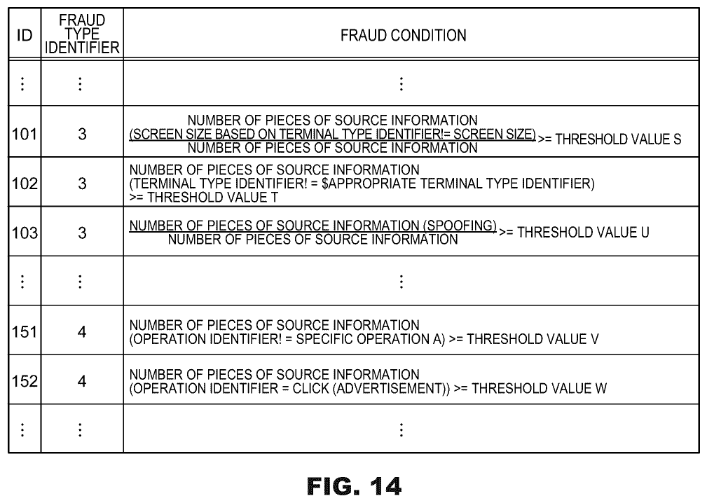

The fraud condition indicated by “ID=101” in FIG. 14 is a condition that the proportion of cases where the screen size corresponding to a terminal type identifier (e.g., “smartphone,” “personal computer”) does not match the screen size included in the source information is greater than or equal to a threshold value S. The fraud condition indicated by “ID=102” is a condition that the number of pieces of source information including inappropriate terminal type identifiers is greater than or equal to a threshold value T. The fraud condition indicated by “ID=103” is a condition that the proportion of pieces of source information judged to be spoofing is greater than or equal to a threshold value U.

The fraud condition indicated by “ID=151” in FIG. 14 is a condition that the number of pieces of source information including an operation identifier “specific operation A” is greater than or equal to a threshold value V. The fraud condition indicated by “ID=152” is a condition that the number of pieces of source information including the operation identifier “CLICK (advertisement)” is greater than or equal to a threshold value W. The number of pieces of source information including the operation identifier “CLICK (advertisement)” is the number of clicks on the same advertisement.

In the situation described above, the fraud detection apparatus 1 operates as follows. That is to say, the reception unit 12 of the fraud detection apparatus 1 receives a large number of pieces of source information from each of one or more servers 2. The processing unit 13 accumulates the received large number of pieces of source information in the storage unit 11. The reception unit 12 of the fraud detection apparatus 1 receives a large number of pieces of source information from each of one or more user terminals 3. The processing unit 13 accumulates the received large number of pieces of source information in the storage unit 11. It is assumed that a large number of pieces of source information are stored in the storage unit 11.

Note that the source information received from the servers 2 and accumulated by the fraud detection apparatus 1 is, for example, download information and has the following structure: (application identifier, network identifier, site identifier, IP address of server 2, IP address of user terminal 3, fingerprint information, OS type identifier, terminal type identifier, language identifier, size information). Such source information is, for example, user operation information and has the following structure: (operation identifier (object identifier), network identifier, site identifier, IP address of server 2, IP address of user terminal 3, fingerprint information, OS type identifier, terminal type identifier, language identifier, size information). Such source information includes, for example, webpage information written in HTML and has the following structure: (network identifier, site identifier, IP address of server 2, webpage information).

The source information received from the user terminal 3 and accumulated by the fraud detection apparatus 1 is, for example, download information and has the following structure: (application identifier, network identifier, site identifier, IP address of server 2, IP address of user terminal 3, fingerprint information, OS type identifier, terminal type identifier, language identifier, size information). Such source information is, for example, installation information and has the following structure: (application identifier, network identifier, site identifier, IP address, fingerprint information, CTIT, OS type identifier, terminal type identifier, language identifier, size information). Such source information is, for example, user operation information and has the following structure: (operation identifier (object identifier), network identifier, site identifier, IP address of server 2, IP address of user terminal 3, fingerprint information, OS type identifier, terminal type identifier, language identifier, size information).

In the situation described above, it is assumed that a predetermined time is reached and the processing unit 13 judges that it is time to perform fraud detection. The following describes four specific examples. Specific Example 1 is a case of acquiring a network detection result. Specific Example 2 is a case of acquiring a site detection result. Specific Example 3 is a case of acquiring an IP address detection result. Specific Example 4 is a case of acquiring a user detection result.

### Specific Example 1

The network information acquisition unit 131 acquires, for each network identifier, one or more pieces of source information each containing a network identifier from the storage unit 11. The network information acquisition unit 131 acquires, for each network identifier, one or more network attribute values using the acquired one or more pieces of source information. Here, the one or more network attribute values include the number of sites and the number of installations. Examples of the one or more network attribute values include the number of language identifiers paired with an operation identifier indicating installation, the number of access origin countries obtained from the IP addresses of the user terminals 3 paired with an operation identifier indicating installation, the number of pieces of source information including an operation identifier corresponding to the CV, the number of pieces of source information not including an appropriate terminal type identifier, and the number of pieces of source information not including an appropriate OS type identifier.

For example, the network information acquisition unit 131 acquires site identifiers from one or more pieces of source information having a network identifier, performs unique processing on the site identifiers, and acquires the number of site identifiers (number of sites) from the result. For example, the network information acquisition unit 131 acquires the number of installations, which is the number of piece of source information including the operation identifier “install” from one or more pieces of source information having a network identifier.

Next, the network fraud detection unit 135 judges, for each network identifier and each network fraud condition, whether or not the network is fraudulent using the network attribute values acquired for the network identifiers based on the network fraud conditions indicated by “ID=1 to 7, 8, and greater” in the fraud condition management table. For example, the network fraud detection unit 135 calculates the number of installations per site using the network fraud condition indicated by “ID=1” for each network identifier and judges that a network is fraudulent if the number of installations is less than or equal to the threshold value A (e.g., “2”).

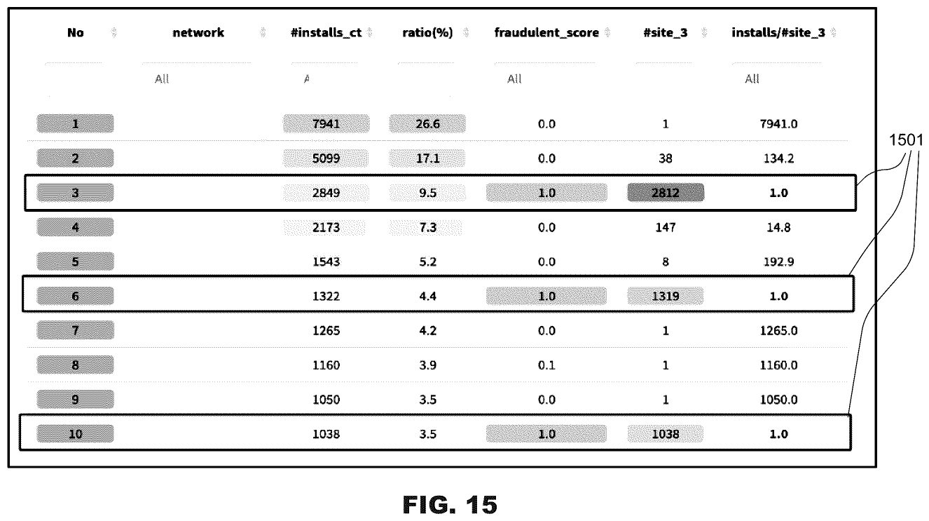

Next, the output unit 141 outputs the result of the network fraud detection. An example of such output is shown in FIG. 15.

In FIG. 15, “No” indicates the network identifier, “#installs_ct” indicates the number of installations, “ratio (%)” indicates the proportion of pieces of source information including the operation identifier “install”, “fraudulent_score” indicates the network detection result indicating whether or not the network is fraudulent, “#site_3” indicates the number of sites, and “installs/#site_3” indicates the number of installations per site. FIG. 15 shows that the networks (1501) indicated by the network identifiers “3, 6, 10” corresponding to the rows enclosed in rectangles are fraudulent.

### Specific Example 2

The site information acquisition unit 132 acquires, for each site identifier, one or more pieces of source information each containing a site identifier from the storage unit 11. The site information acquisition unit 132 acquires, for each site identifier, one or more site attribute values using the acquired one or more pieces of source information. Here, the one or more site attribute values include, for example, a CTIT, an OS type identifier, a terminal type identifier, the IP address corresponding to the user identifier, a language identifier, and webpage information.

Next, the site fraud detection unit 136 judges, for each site identifier and each site fraud condition, whether or not the site is fraudulent, using the site attribute values acquired for the site identifiers based on the fraud conditions indicated by “ID=51 to 59, and so on” in the fraud condition management table.

For example, the site fraud detection unit 136 acquires, for each site, CTIT distribution information, using the site fraud condition indicated by “ID=51” and compares it with the CTIT legitimate distribution information in the legitimate information storage unit 111. Here, the network fraud detection unit 135 acquires CTIT distribution information (average value, median value, standard deviation, minimum value, maximum value) from the set of CTITs for each site.

Here, it is assumed that the site fraud detection unit 136 acquires, for example, CTIT distribution information (10.7, 3.7, 1.3, 0.1, 1428.8) from CTITs contained in two or more pieces of source information for a site. It is also assumed that the CTIT legitimate distribution information indicates (33.9, 0.8, 9.4, 0.3, 1439.7). It is assumed that the site fraud detection unit 136 calculates the distance between two vectors (10.7, 3.7, 1.3, 0.1, 1428.8) and (33.9, 0.8, 9.4, 0.3, 1439.7) and judges that the distance is greater than or equal to the threshold value H. In other words, the site fraud detection unit 136 acquires a site detection result indicating that the CTIT distribution information of the site is not legitimate and that the site is fraudulent.

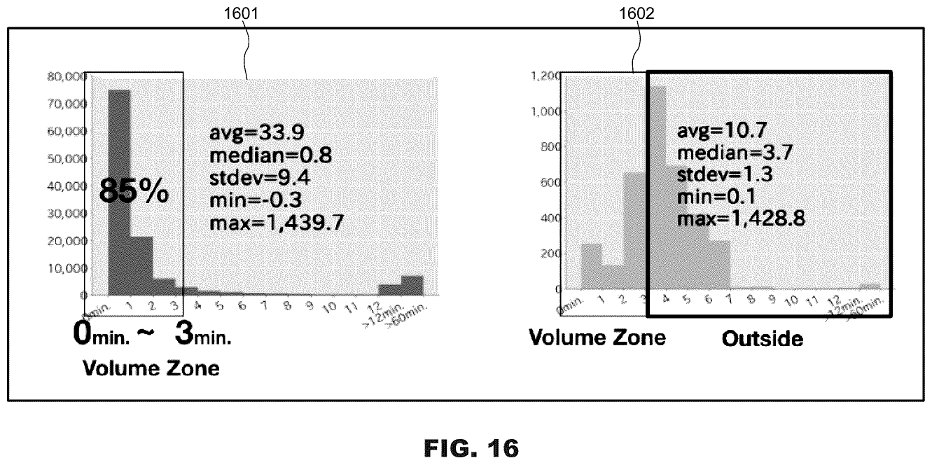

Next, the output unit 141 outputs the result of the site fraud detection. An example of such output is shown in FIG. 16. In FIGS. 16, 1601 indicates the CTIT legitimate distribution information, and 1602 indicates the CTIT distribution information of the site. In FIG. 16, both the CTIT legitimate distribution information and the CTIT distribution information contain an average value (avg), a median value (median), a standard deviation (stdev), a minimum value (min), and a maximum value (max).

For example, the site fraud detection unit 136 also acquires, for each site, OS type distribution information, using the site fraud condition indicated by “ID=52” and compares it with the OS type legitimate distribution information in the legitimate information storage unit 111. Here, the site fraud detection unit 136 calculates the distance between a vector constructed from the OS type distribution information for each site and a vector formed from the OS type legitimate distribution information to judge whether or not each site is fraudulent. The OS type distribution information and the OS type legitimate distribution information indicate the proportions of pieces of source information for each OS type.

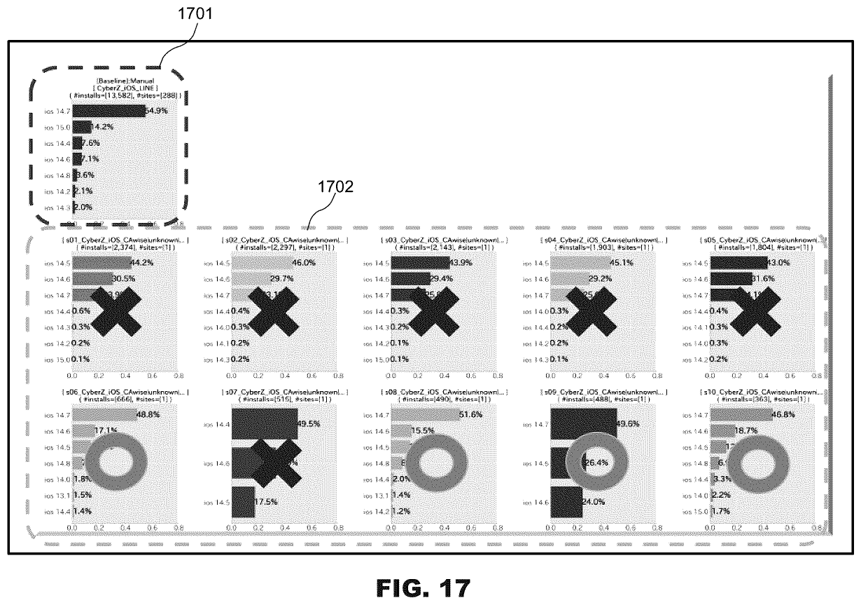

Next, the output unit 141 outputs the result of the fraud detection of the OS type identifiers for the site. An example of such output is shown in FIG. 17. In FIGS. 17, 1701 indicates the OS type legitimate distribution information, and 1702 indicates the OS type distribution information for each site. In FIG. 17, “×” indicates a fraudulent site, and “○” indicates a legitimate site.

### Specific Example 3

The IP address information acquisition unit 133 acquires, for each of the IP address of the servers 2 accessed, one or more pieces of source information each containing an IP address from the storage unit 11. The IP address information acquisition unit 133 acquires, from the acquired source information, one or more IP address attribute values used to judge whether or not each piece of source information corresponds to spoofing. Here, the one or more IP address attribute values include, for example, a terminal type identifier and a screen size.

The IP address fraud detection unit 137 judges whether or not each piece of source information corresponds to spoofing, using the one or more IP address attribute values. Here, for example, the IP address fraud detection unit 137 judges that source information corresponds to spoofing if a screen size corresponding to the terminal type identifier does not match the screen size included in the source information.

Next, the IP address fraud detection unit 137 acquires, for each IP address, the total number of pieces of source information and the number of pieces of source information judged to correspond to spoofing. Next, the IP address fraud detection unit 137 calculates, for each IP address, the spoofing proportion (the number of pieces of source information judged to correspond to spoofing divided by the total number of pieces of source information). Next, the IP address fraud detection unit 137 judges that an IP address is fraudulent if the spoofing proportion is greater than or equal to the threshold value U (here, 95%). Next, the IP address fraud detection unit 137 acquires an IP address detection result including the IP addresses on which fraud detection based on spoofing has been performed.

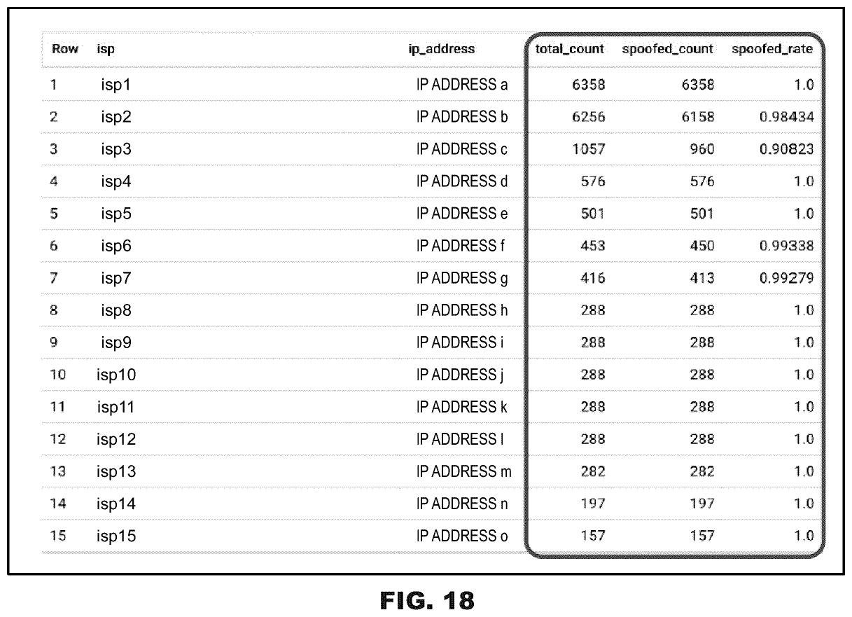

Next, the output unit 141 outputs the IP address detection result. An example of such output is shown in FIG. 18. In FIG. 18, “Row” indicates the ID of the record, “isp” indicates the organization name corresponding to the IP address, “ip_adress” indicates the IP address, “total_count” indicates the total number of pieces of source information, “spoofed_count” indicates the number of pieces of source information corresponding to spoofing, and “spoofed_rate” indicates the spoofing proportion. FIG. 18 shows that all of the IP addresses are fraudulent. This is because “spoofed_rate” is 0.95 or higher.

### Specific Example 4

The user operation information acquisition unit 134 acquires source information from the storage unit 11, for each piece of fingerprint information. Next, the user operation information acquisition unit 134 acquires, for each piece of fingerprint information, the number of pieces of source information including the operation identifier “specific operation A” from the acquired source information. The user operation information acquisition unit 134 acquires, for each piece of fingerprint information, the number of pieces of source information including the operation identifier “CLICK” corresponding to the pieces of advertising information from the acquired source information.

Next, the user fraud detection unit 138 judges, for each piece of fingerprint information and each user fraud condition, whether or not the user is fraudulent, using the user attribute values (e.g., the number of pieces of source information including the operation identifier “specific operation A”) acquired for each piece of fingerprint information, based on the user fraud conditions indicated by “ID=151, 152, etc.” in the fraud condition management table. The user fraud detection unit 138 acquires a user detection result.

Next, the output unit 141 outputs the user detection result indicating whether or not the user is fraudulent.

As described above, according to the present embodiment, it it possible to perform comprehensive fraud detection across all layers of the three-layer structure, namely the network, site, and IP address layer.

In addition, according to the present embodiment, it is possible to perform more comprehensive fraud detection, including fraud detection targeting users.

Note that the processing in the present embodiment may be realized using software. This software may be distributed through software downloading or the like. Also, this software may be recorded on a recording medium such as a CD-ROM and distributed. Note that the same applies to the other embodiments in the present specification. Note that the software that realizes the fraud detection apparatus 1 according to the present embodiment is the program described below. That is to say, the program is program for enabling a computer to function as: a network information acquisition unit that acquires network information regarding a network including one or more sites; a network fraud detection unit that performs fraud detection targeting the network, using the network information acquired by the network information acquisition unit, to acquire a network detection result; a site information acquisition unit that acquires site information regarding a site; a site fraud detection unit that performs fraud detection targeting the site, using the site information acquired by the site information acquisition unit, to acquire a site detection result; an IP address information acquisition unit that acquires IP address information regarding an IP address; an IP address fraud detection unit that performs fraud detection targeting the IP address, using the IP address information acquired by the IP address information acquisition unit, to acquire an IP address detection result; and an output unit that outputs the network detection result, the site detection result, and the IP address detection result.

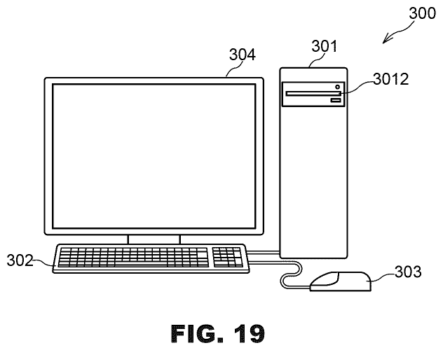

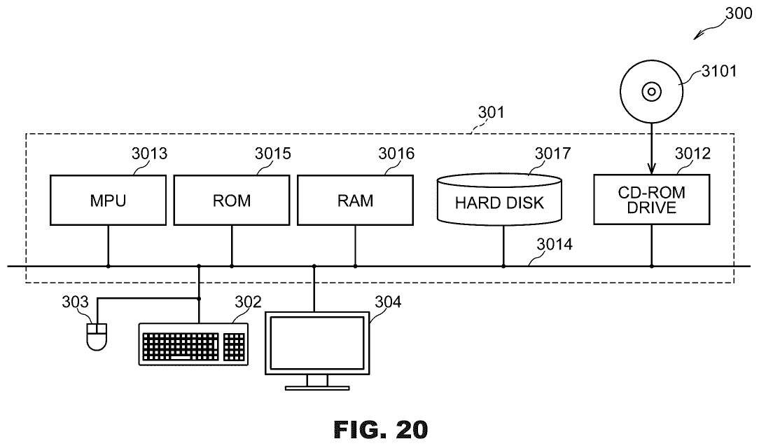

FIG. 19 shows an external view of a computer that executes the program described in the present specification to realize the fraud detection apparatus 1, the servers 2, and the user terminals 3 according to the various embodiments described above. The above-described embodiments can be realized using computer hardware and a computer program executed thereon. FIG. 19 is an overview diagram of this computer system 300, and FIG. 20 is a block diagram of the system 300.

In FIG. 19, the computer system 300 includes a computer 301, which includes a CD-ROM drive, a keyboard 302, a mouse 303, and a monitor 304.

In FIG. 20, the computer 301 includes, in addition to the CD-ROM drive 3012, an MPU 3013, a bus 3014 that is connected to the CD-ROM drive 3012 and so on, a ROM 3015 for storing programs such as a boot-up program, a RAM 3016 that is connected to the MPU 3013 and is used to temporarily store application program instructions and provide a temporary storage space, and a hard disk 3017 for storing application programs, system programs, and data. Here, although not shown in the figure, the computer 301 may further include a network card that provides connection to a LAN.

The program that enables the computer system 300 to perform the functions of the fraud detection apparatus 1 and so on according to the above-described embodiments may be stored in the CD-ROM 3101, inserted into the CD-ROM drive 3012, and furthermore transferred to the hard disk 3017. Alternatively, the program may be transmitted to the computer 301 via a network (not shown) and stored on the hard disk 3017. The program is loaded into the RAM 3016 when the program is to be executed. The program may be directly loaded from the CD-ROM 3101 or the network.

The program does not necessarily have to include an operating system (OS), a third party program, or the like that enables the computer 301 to perform the functions of the fraud detection apparatus 1 and so on according to the embodiments described above. The program need only contain the part of the instruction that calls an appropriate function (module) in a controlled manner to achieve a desired result. How the computer system 300 works is well known and the detailed descriptions thereof will be omitted.

In the above-described program, the step of transmitting information, the step of receiving information and so on do not include processing performed by hardware, for example, processing performed by a modem or an interface card in the step of transmitting (processing that can only be performed by hardware).

There may be a single or multiple computers executing the above-described program. That is to say, centralized processing or distributed processing may be performed.

Also, as a matter of course, in each of the above-described embodiments, two or more communication means that are present in one apparatus may be physically realized using one medium.

Also, in the above-described embodiments, each kind of processing may be realized as centralized processing that is performed by a single apparatus, or distributed processing that is performed by multiple apparatuses.

As a matter of course, the present invention is not limited to the above-described embodiments, and various changes are possible, and such variations are also included within the scope of the present invention.

### Industrial Applicability

As described above, the fraud detection apparatus 1 according to the present invention has the effect of enabling comprehensive fraud detection across all layers of the three-layer structure, namely the network, site, and IP address layer, and is useful as a server or the like for detecting fraud.

1. A fraud detection apparatus comprising:
a network information acquisition unit that acquires network information regarding a network including one or more sites;
a network fraud detection unit that performs fraud detection targeting the network, using the network information acquired by the network information acquisition unit, to acquire a network detection result;
a site information acquisition unit that acquires site information regarding a site;
a site fraud detection unit that performs fraud detection targeting the site, using the site information acquired by the site information acquisition unit, to acquire a site detection result;
an IP address information acquisition unit that acquires IP address information regarding an IP address;
an IP address fraud detection unit that performs fraud detection targeting the IP address, using the IP address information acquired by the IP address information acquisition unit, to acquire
an IP address detection result; and
an output unit that outputs the network detection result, the site detection result, and the IP address detection result,
wherein the network information acquisition unit acquires two or more network attribute values including one or more network attribute values out of: the number of application downloads in the network, the number of sites belonging to the network, the number of accesses from user terminals with a non-Japanese language setting, the number of application installations from user terminals with a non-Japanese language setting, the number of accesses from user terminals with non-Japan access origins, the number of application installations from user terminals with non-Japan access origins, the number of operation identifiers corresponding to CV operations, the number of accesses from user terminals of types identified by terminal type identifiers of terminals that satisfy a predetermined condition, and the number of accesses from user terminals equipped with OSs identified by OS type identifiers of OSs that satisfy a predetermined condition, and
the network fraud detection unit uses the two or more network attribute values to perform the fraud detection targeting the network, thereby acquiring the network detection result,
wherein the site information acquisition unit acquires site distribution information regarding the distribution of feature values of the site, and
the site fraud detection unit uses the site distribution information to perform the fraud detection targeting the site, thereby acquiring the site detection result,
wherein the site distribution information includes any one of: information regarding the distribution of CTITs; information regarding the distribution of OS version shares, which are the shares of OS versions of user terminals from which the site is accessed; information regarding the distribution of user terminal shares, which are the shares of types of user terminals from which the site is accessed; information regarding the distribution of provider shares, which are the shares of types of providers from which the site is accessed; and information regarding the distribution of regional shares, which are shares of region types from which the site is accessed,
wherein the IP address information acquisition unit acquires one or more IP address attribute values including type-specific access counts, which are the respective numbers of user terminals accessing the IP address for one or more user terminal types, and
the IP address fraud detection unit uses the one or more IP address attribute values to perform the fraud detection targeting the IP address, thereby acquiring the IP address detection result.

2. The fraud detection apparatus according to claim 1, further comprising:
a user operation information acquisition unit that acquires user operation information regarding an operation performed by a user; and
a user fraud detection unit that performs fraud detection targeting the user, using the user operation information acquired by the user operation acquisition unit, to acquire a user detection result,
wherein the output unit further outputs the user detection result.

3. (canceled)

4. The fraud detection apparatus according to claim 1,
wherein the network information acquisition unit acquires a network attribute value that is network distribution information regarding the distribution of feature values of the network, and
the network fraud detection unit uses the network attribute value to perform the fraud detection targeting the network, thereby acquiring the network detection result.

5. The fraud detection apparatus according to claim 4, further comprising:
a legitimate information storage unit in which network legitimate distribution information specifying legitimate information regarding the network distribution information is stored,
wherein the network fraud detection unit acquires network distribution difference information regarding a difference between the network distribution information acquired by the network information acquisition unit and the network legitimate distribution information, and uses the network distribution difference information to acquire the network detection result, and
the fraud detection apparatus further comprises a legitimate information update unit that updates the network legitimate distribution information when a predetermined update condition is satisfied.

6. (canceled)

7. (canceled)

8. The fraud detection apparatus according to claim 1 further comprising:
a legitimate information storage unit in which site legitimate distribution information specifying legitimate information for the site distribution information is stored,
wherein the site fraud detection unit acquires site distribution difference information regarding a difference between the site distribution information acquired by the site information acquisition unit and the site legitimate distribution information, and uses the site distribution difference information to acquire the site detection result, and
the fraud detection apparatus further comprises a legitimate information update unit that updates the site legitimate distribution information when a predetermined update condition is satisfied.

9. The fraud detection apparatus according to claim 1,
wherein the site information acquisition unit acquires two or more tag counts, which are the numbers of specific tags of two or more types used to describe the site, and
the site fraud detection unit uses the two or more tag counts to perform the fraud detection targeting the site, thereby acquiring the site detection result.

10. The fraud detection apparatus according to claim 9,
wherein the site fraud detection unit clusters two or more sites using two or more tag counts of each of the two or more sites, and judges a site to be fraudulent and acquires the site detection result if the site belongs to the same cluster as a site judged to be fraudulent by an inspection performed using the two or more tag counts, even if the site has not been judged to be fraudulent by the inspection performed using the two or more tag counts.

11. The fraud detection apparatus according to claim 1,
wherein the site information acquisition unit acquires site information regarding two or more sites, and
the site fraud detection unit performs a preliminary inspection, using the site information, to judge whether or not each of two or more sites is a candidate for being a fraudulent site, and performs a detailed inspection, using the site information of one or more sites judged to be fraudulent in the preliminary inspection, to judge whether or not each of the one or more sites is a fraudulent site, thereby acquiring the site detection result.

12. (canceled)

13. The fraud detection apparatus according to claim 1,
wherein the IP address information acquisition unit acquires, for an IP address, two or more IP address attribute values including a type identifier that specifies a type of a user terminal and size information that specifies a screen size of the user terminal, and
the IP address fraud detection unit acquires an IP address detection result indicating that an IP address is fraudulent when the number of two or more IP address attribute values for which a screen size corresponding to the type identifier included in the two or more IP address attribute values does not match the screen size indicated by the size information is sufficiently large to satisfy a fraud condition.

14. The fraud detection apparatus according to claim 2,
wherein the user operation acquisition unit acquires two or more pieces of user operation information paired with a piece of finger print information, and
the user fraud detection unit acquires a user detection result indicating that a user is fraudulent when the two or more pieces of user operation information include a large number of pieces of operation information indicating a specific operation, the large number being sufficiently large to satisfy a frequency condition.

15. The fraud detection apparatus according to claim 14, further comprising:
a legitimate information storage unit in which frequency legitimate information indicating a legitimate frequency of the pieces of operation information indicating the specific operation,
wherein the user fraud detection unit acquires a user detection result indicating that a user is fraudulent when the two or more pieces of user operation information include a large number of pieces of frequency information of operation information indicating the specific operation, the large number being sufficiently large to satisfy a frequency condition relative to the frequency legitimate information.

16. A fraud detection method realized using a network information acquisition unit, a network fraud detection unit, a site information acquisition unit, a site fraud detection unit, an IP address information acquisition unit, an IP address fraud detection unit, and an output unit, the fraud detection method comprising:
a network information acquisition step in which the network information acquisition unit acquires network information regarding a network including one or more sites;
a network fraud detection step in which the network fraud detection unit performs fraud detection targeting the network, using the network information acquired in the network information acquisition step, to acquire a network detection result;
a site information acquisition step in which the site information acquisition unit acquires site information regarding a site;
a site fraud detection step in which the site fraud detection unit performs fraud detection targeting the site, using the site information acquired in the site information acquisition step, to acquire a site detection result;
an IP address information acquisition step in which the IP address information acquisition unit acquires IP address information regarding an IP address;
an IP address fraud detection step in which the IP address fraud detection unit performs fraud detection targeting the IP address, using the IP address information acquired in the IP address information acquisition step, to acquire an IP address detection result; and
an output step in which the output unit outputs the network detection result, the site detection result, and the IP address detection result.

17. A recording medium having recorded thereon a program that enables a computer to function as:
a network information acquisition unit that acquires network information regarding a network including one or more sites;
a network fraud detection unit that performs fraud detection targeting the network, using the network information acquired by the network information acquisition unit, to acquire a network detection result;
a site information acquisition unit that acquires site information regarding a site;
a site fraud detection unit that performs fraud detection targeting the site, using the site information acquired by the site information acquisition unit, to acquire a site detection result;
an IP address information acquisition unit that acquires IP address information regarding an IP address;
an IP address fraud detection unit that performs fraud detection targeting the IP address, using the IP address information acquired by the IP address information acquisition unit, to acquire an IP address detection result; and
an output unit that outputs the network detection result, the site detection result, and the IP address detection result.
